(19) United States
(12) Patent Application Publication
(10) Pub. No.: US 2025/0109629 A1
(43) Pub. Date: Apr. 3, 2025

(54) A ROOF WINDOW COMPRISING A FRAME WITH AN INTERFACE UNIT

(71) Applicant: VKR Holding A/S, Hørsholm (DK)

(72) Inventors: ASBJØRN SKYUM BLICHFELDT, Odder (DK); CLAUS HOLM, Silkeborg (DK); RASMUS FOGELBERG SKOV, Horsens (DK)

(21) Appl. No.: 18/849,046

(22) PCT Filed: Mar. 31, 2023
(86) PCT No.: PCT/DK2023/050077

§ 371 Date: Sep. 20, 2024

(30) Foreign Application Priority Data
Mar. 31, 2022 (DK) PA 2022 70160

(51) Int. Cl. E06B 7/23; E04D 13/03

(52) U.S. Cl. CPC E06B 7/2312; E04D 13/0305

(57) ABSTRACT

In the roof window, an interface unit (8) is provided to interact with auxiliary equipment and/or other components of the roof window (1) in an assembled condition of the frame (2). The interface unit (8) comprises a top interface element and two side interface elements (82, 83) received in a receiving structure comprising an interface unit groove in an exterior side of the top frame member and two side members (22, 23).

### TECHNICAL FIELD

The present invention relates to a roof window comprising a frame, a sash, and a pane, in which the frame comprises a set of frame members including a top frame member, two side frame members and a bottom frame member and the sash comprises a set of sash members including a top sash member, two side sash members and a bottom sash member.

### BACKGROUND ART

Roof windows to be installed in inclined roof surfaces come in a variety of types. When selecting a roof window type for a specific installation location in a building, parameters such as operability, thermal properties, weather-tightness, and suitable finishing to the interior of the building are typically given substantial weight; however, it is also often desired and in some areas in fact necessary to factor in the external appearance as well. This applies in particular when installing roof windows in conservation areas, in which building regulations may demand that the roof windows meet standard or local requirements. Thus, certain requirements apply depending on whether the installation concerns a newly fitted roof window, or to replace an existing window or rooflight as part of a renovation or refurbishment project.

The windows or rooflights of past times were typically made of cast iron with single glass pane pieces, separated by one or more cast iron glazing bars, and the thermal efficiency of these roof windows or rooflights left room for improvement. To fulfil the energy performance required by modern day building regulations, conservation roof windows are typically provided with an insulating pane, while at the same time setting out to mimic the look of traditional rooflights.

In many installation situations it is a further requirement that the conservation roof window is able to be installed with a “low profile”, i.e. that the height of the parts of the roof window protruding above the surrounding roofing is as small as possible. This is particularly pronounced in buildings with substantially flat roofing materials, such as slate or shingle. To meet this requirement, most major roof window manufacturers allow installation in at least two levels, thus accommodating the height of various roofing profiles and installation conditions.

With an ever-increasing awareness of environmental considerations and the wish to reduce or even eliminate the climate footprint of products, there is furthermore a need for providing products which are more environmentally friendly in terms of manufacturing, supply, installation, and use.

Taking all of the above requirements into account, it is an ongoing quest to improve a roof window for conservation purposes.

### SUMMARY OF INVENTION

With this background, it is an object of the invention to provide a roof window by which the manufacturing, assembly and installation process is rendered more flexible while at the same time, the roof window provides for adequate protection against the weather when in use.

This and further objects are achieved with a roof window of the kind mentioned in the introduction which is furthermore characterised in that an interface unit is provided to interact with auxiliary equipment and/or other components of the roof window in an assembled condition of the frame.

The provision of a single interface unit ensures that suitable interaction with auxiliary equipment such as sealing profiles and coverings is made possible in a simple way. Manufacture, assembly and installation may be carried out securely. Other components that are eligible for interaction with the interface unit include the sash. This is particularly relevant in cases where the interface unit has a sealing function.

In a presently preferred embodiment, the interface unit comprises a top interface element and two side interface elements configured to be received in a receiving structure comprising an interface unit groove in an exterior side of the top frame member and two side members. In this way, it is possible to easily fasten the interface elements to the frame and thereby obtain central functionalities towards the sash and for instance a surrounding covering assembly. The interface elements thus provide a coherent structure along the top and the sides in the form of a football goal.

In a further development of this preferred embodiment, each interface element comprises a base portion with an anchor section, said anchor section being configured to be received in the interface unit groove in the exterior side of the top frame member and two side members. By dividing the interface unit into different functional sections including a base portion, it is possible to confer different properties to different sections. For instance, fastening the interface elements will require different properties and it thus possible to tailor the properties of the anchor section such that appropriate retention is achieved.

In a presently preferred embodiment, the interface unit forms part of an exterior sealing plane relative to the sash. By this design, additional protection against the weather is provided in that the exterior sealing plane provides a first shield against weather including rain and other precipitation, wind, sound etc. To protect the unavoidable gap between the frame and the sash, the intermediate and interior sealing planes provide additional security.

Preferably, the exterior sealing plane is provided by the interface element at the top frame and sash members and side frame and sash members. In this way, vital weather-proofing is obtained at the location where the sash and frame adjoin in the closed position of the sash.

Each interface element preferably comprises an inner leg and an outer leg, which inner leg and outer leg extend towards the exterior from a base portion, a flange and a sealing portion. In this way, each interface element is provided with a certain extent in the height and width directions, thus facilitating the interaction with other elements.

In a preferred further development, the inner leg, the outer leg, and the flange form a channel in the top interface element and the side interface elements. In this way, the interface unit provides a guiding canal for water emanating from rain and other precipitation.

To improve the sealing properties even further, the sealing portion comprises an inner sealing lip and an outer sealing lip.

Preferably, the top interface element comprises an additional inner sealing lip, a first additional outer sealing lip and a second additional outer sealing lip. This has proven to improve the sealing properties even further.

To improve the versatility of the interface unit, the base portion, the inner leg and the flange form a flashing reception groove in one embodiment. This makes it possible to provide interaction of the roof window with a covering assembly and thus provide a weather-proof transition to the surrounding roofing in a simple and efficient manner.

Each interface element may be provided as a two-component element, wherein at least the sealing portion has different properties than at least the base portion. Since the base portion has as its primary function to ensure reliable connection to the frame of the roof window, the base portion will typically need to possess stiffer material properties than the sealing portion which needs to be elastic and flexible.

In order to improve the structural integrity and ensuing proper functioning of the interface unit at the top of the roof window, a stabilising plate may be placed in a channel of the top element of the interface unit.

While the configuration of the sash members including a profile element by itself entails appropriate guidance of water onto the surrounding, an extension plate may be fastened to the profile element of the top sash member to protrude into a channel of the top element of the interface unit. This ensures proper guidance of water into the channel of the interface unit even in roof windows built into roofs with a large inclination.

Improved retention of the interface unit may be achieved by a clip mounted on the side element of the interface unit, the clip being provided with a clip flange to interact with an end plug flange of an end plug of the sash side member so as to allow the end plug flange to overlap the clip flange in the closed position of the roof window.

Other presently preferred embodiments and further advantages will be apparent from the subsequent detailed description and drawings.

A feature described in relation to one of the aspects may also be incorporated in the other aspect, and the advantage of the feature is applicable to all aspects in which it is incorporated.

### BRIEF DESCRIPTION OF DRAWINGS

In the following description embodiments of the invention will be described with reference to the drawings, in which

FIG. 1 is a perspective view of a roof window in an embodiment of the invention, seen from an interior side;

FIG. 2 is a perspective view of the roof window of FIG. 1, seen from an exterior side;

FIG. 3 is a perspective cross-sectional view of a side of a roof window in another embodiment, with a mounting bracket, corresponding to a cross-section along the line III-III in FIG. 2;

FIG. 4 is a view corresponding to FIG. 3, with an insulating frame piece shown exploded;

FIG. 5 is a cross-sectional view along the line III-III in FIG. 2;

FIG. 6 is a cross-sectional view of a roof window in a further embodiment, corresponding to a cross-section along the line VI-VI in FIG. 2;

FIG. 7 is a view corresponding to FIG. 6, with the sash in an open position;

FIG. 8 is a perspective cross-sectional view of a roof window in an embodiment incorporating an operating assembly, corresponding to a cross-section along the line VIII-VIII in FIG. 2;

FIG. 9 is a cross-sectional view along a line parallel to the line VIII-VIII in FIG. 2;

FIG. 10 is a partial perspective view of a roof window incorporating a hinge assembly and an operating assembly, with the sash in an open position;

FIG. 11 is a partial perspective sectional view of the frame of the roof window of FIG. 10, together with an insulating frame;

FIG. 12a is a partial perspective view of the sash of the roof window of FIG. 10;

FIG. 12b is a perspective sectional view of the sash of FIG. 12a;

FIG. 13a is an exploded sectional view of the details of FIG. 12a;

FIG. 13b is a perspective view of a detail of the sash of FIG. 12a;

FIG. 14a is a partially exploded perspective view of the sash of FIG. 12a;

FIG. 14b is a perspective sectional view of details shown in FIG. 13a;

FIG. 15 is a partial perspective view of an intermediate element of the sash of the roof window of FIG. 10;

FIG. 16 is a sectional view corresponding to FIG. 5, but of the sash isolated from the frame;

FIG. 17 is a simplified cross-sectional view corresponding to FIG. 16;

FIG. 18 is a view corresponding to FIG. 17, of a roof window in another embodiment of the invention, in which the pane has a larger total thickness;

FIG. 19 is an exploded perspective view of an upper corner of the sash of a roof window in a further embodiment;

FIGS. 20 and 21 are perspective views, seen from different angles, of a corner key of the sash of FIG. 19;

FIG. 22 is an exploded perspective view of a sash and a frame of a roof window in an embodiment incorporating a hinge assembly;

FIG. 23 is a partial perspective view of details of the roof window of FIG. 22;

FIG. 24 is a perspective view of a roof window in an embodiment of the invention, incorporating a flashing assembly;

FIG. 25 is a partial perspective exploded view of an upper corner of the frame of the roof window in the embodiment of FIG. 24;

FIGS. 26 and 27 are cross-sectional views of elements of the interface unit of FIG. 25;

FIG. 28 is a partial side view of a roof window in the open position shown in FIG. 7, showing the interaction between the sash and the interface unit of FIG. 25; and

FIG. 29a is a cross-sectional view along the line XXIX-XXIX in FIG. 24;

FIG. 29b is a view corresponding to FIG. 29a, of an alternative embodiment of the general embodiment of FIG. 24;

FIG. 30 is a cross-sectional view of an alternative embodiment, corresponding to a cross-sectional view along the line XXX-XXX of the general embodiment of FIG. 24;

FIG. 31 is a cross-sectional view of an alternative embodiment, corresponding to a cross-sectional view along the line XXXI-XXXI of the general embodiment of FIG. 24;

FIG. 32 is a partial perspective view of the top right-hand corner of the alternative embodiment of the roof window;

FIG. 33 is a partial sectional view of the top right-hand corner of an embodiment of the roof window according to the invention;

FIG. 34 is a partial perspective view of the bottom right-hand corner of the alternative embodiment of the roof window;

FIG. 35 is a perspective view, on a larger scale, of a detail of the embodiment of FIG. 34; and

FIG. 36 is a perspective view, on a larger scale, of a further detail of the embodiment of FIG. 34.

### DESCRIPTION OF EMBODIMENTS

In the following detailed description, a preferred embodiment of the present invention will be described. However, it is to be understood that features of the different embodiments are exchangeable between the embodiments and may be combined in different ways, unless anything else is specifically indicated. It may also be noted that, for the sake of clarity, the dimensions of certain components illustrated in the drawings may differ from the corresponding dimensions in real-life implementations.

It is noted that terms such as “up”, “down”, “left-hand”, “right-hand”, “exterior”, “interior”, “outer”, “inner” are relative and refers to the viewpoint in question. In general, when referred to an exterior side, this relates to a side of a roof window in the mounted condition facing the outdoors or external side of the building. Conversely, an interior side refers to a side facing the internal side of the building, i.e. typically a subjacent room including any light shaft. Terms such as “outwards” and “inwards” are directions generally perpendicular to an interior-exterior direction, taking as its base point a centre of the roof window.

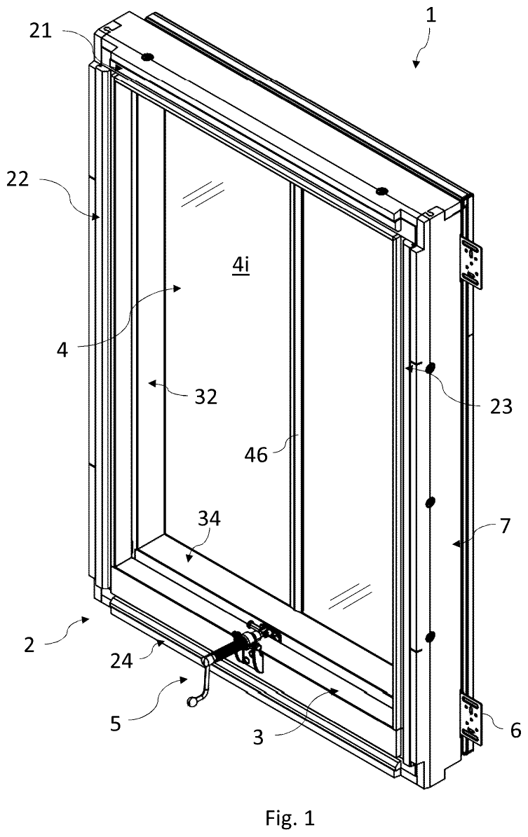

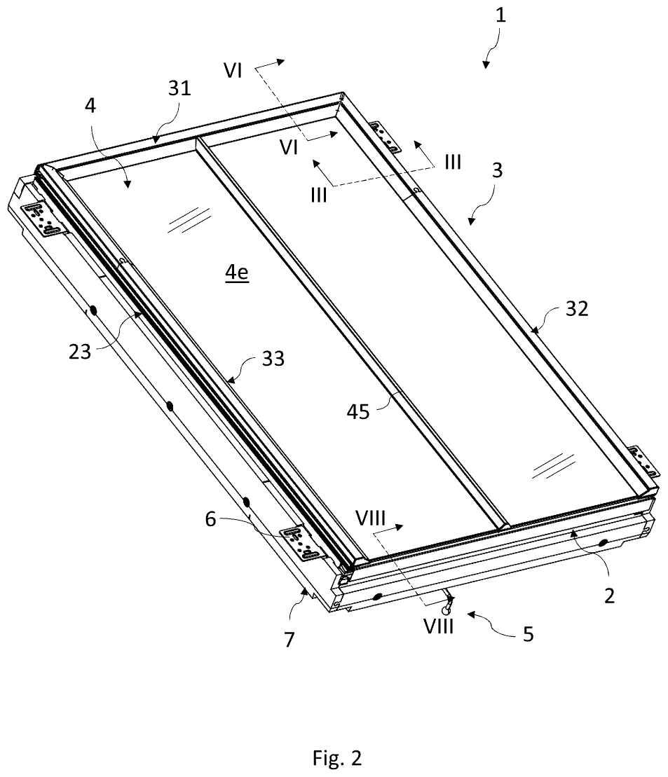

### General Description of a Roof Window—FIGS. 1 and 2

Referring initially to FIGS. 1 and 2, a roof window 1 is shown. The roof window 1 is intended to be installed in an inclined roof surface (not shown).

The roof window 1 comprises a frame 2, a sash 3, and a pane 4. The frame 2 comprises a set of frame members including a top frame member 21, two side frame members 22, 23 and a bottom frame member 24.

Correspondingly, the sash 3 comprises a set of sash members including a top sash member 31, two side sash members 32, 33 and a bottom sash member 34. While the frame 2 and sash 3 are described as rectangular structures, some principles of the presented concepts may be applicable to other geometrical shapes as well.

The pane 4 comprises a number of edge portions generally associated to members of the sash 3 as will be described in further detail below. When in a closed position, an exterior pane surface 4e defines a plane of the roof window 1 in an assembled condition of the roof window 1. The assembled condition of the roof window 1 is achieved when main components of the frame 2 and sash 3 have been assembled and the frame 2 and sash 3 are connected to each other, for instance in an installed position when the roof window 1 is ready for use. Correspondingly, an assembled condition of the sash 3 is achieved once main components of the sash 3 have been assembled, and an assembled condition of the frame 2 when main components of the frame 2 are assembled.

An interior pane surface 4i faces the interior, typically a room of a building subjacent the roof surface in which the roof window 1 is installed. A glazing bar 45 is fitted to the exterior pane surface 4e, and a glazing bar cover 46 is fitted on the interior pane surface 4i. Although less practical, it would also be possible to have a two-part pane with two pane halves divided by a throughgoing glazing bar. In wide roof windows, it is also possible to have more than one glazing bar, for instance two glazing bars dividing the surface of the pane visible from the exterior into three sections.

In the embodiments shown, the sash 3 is openable relative to the frame 2, to obtain one or more open positions. In such open positions, the sash 3 and pane 4 are moved out of the plane of the roof window 1. As will be described in the following, the sash 3 is shown as being tophung, i.e. during normal use, the sash 3 is rotated about a substantially horizontal hinge axis at or near the top frame member 21 and top sash member 31. It is however conceivable to apply some principles of the presented concepts for roof windows on different types of windows having other opening patterns, or being provided as fixed skylights.

Further details shown in FIGS. 1 and 2 include an operating assembly 5, here shown as a manual handwinder or screwjack. Other operating assemblies may be present as well.

Also shown is a representative mounting bracket 6 forming part of a plurality of mounting brackets forming a load-transferring connection between the roof window 1 and a surrounding roof structure (not shown). Such a roof structure may include rafters and battens, plywood or other construction materials.

Finally, an insulating frame 7 is shown. Insulation by an insulating frame is optional and may be provided along only some of the frame members or as shown surrounding all four frame members 21, 22, 23, 24.

In the following description of various embodiments, elements having the same or analogous function carry the same reference numerals throughout. Suitable variations and modifications will be apparent to the person skilled in the art.

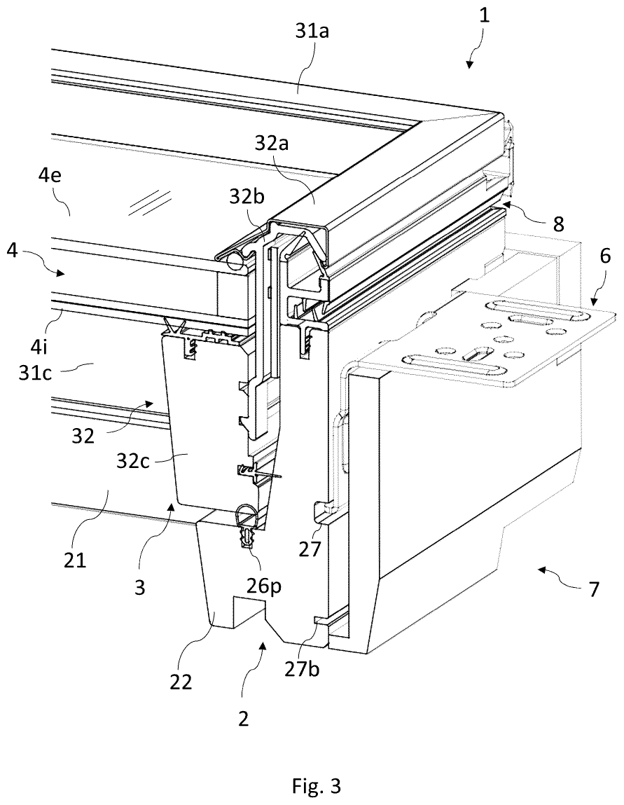

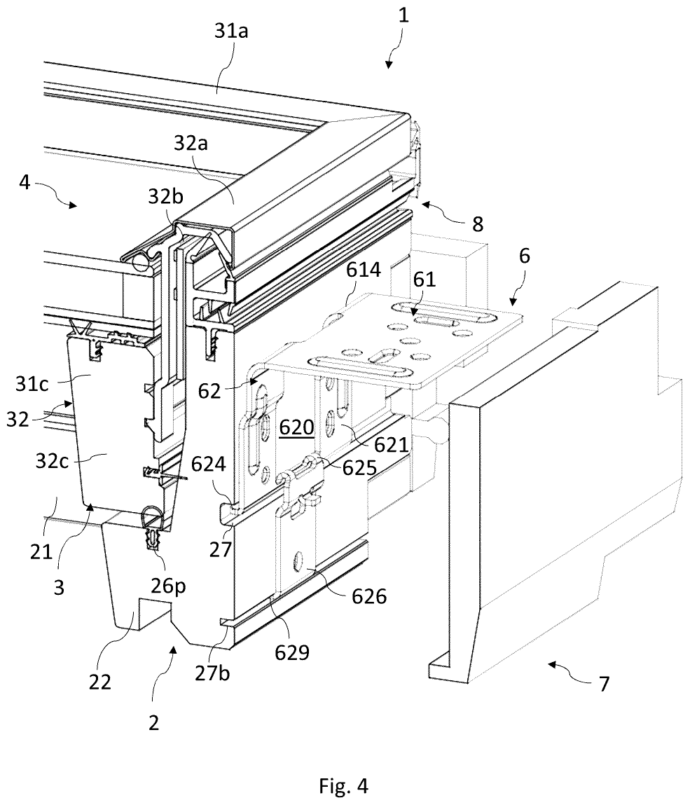

Mounting Bracket and Roof Window with Set of Mounting Brackets—FIGS. 3 to 4

Typically, a roof window such as the roof window 1 shown in FIGS. 1 and 2 is supplied with a set of mounting brackets 6. As indicated, two mounting brackets 6 are fastened to each side frame member 22, 23. In the following, a single mounting bracket 6 will be described, in association with one side frame member 22. The mounting brackets 6 of the set will most often be identical, although variations are possible.

The mounting bracket 6 comprises a first bracket leg 61 for fastening to the roof structure and a second bracket leg 62 for fastening to the frame 2 of the roof window 1. To that end, the second bracket leg 62 comprises engagement means to interact with a corresponding receiving structure in an outer side of the side frame member 22 of the frame 2 of the roof window 1. This ensures that the mounting bracket 6 is positioned correctly on the side frame member 22 and facilitates the installation process. The positioning of the mounting bracket 6 may be indicated in both the longitudinal direction and the height direction of the side frame member 22, for instance by suitable markings and/or holes. The first bracket leg 61 of the mounting bracket 6 is connected to the second bracket leg 62 via a bend 614.

In the embodiment shown, the second bracket leg 62 is provided with a first engagement means 624 in a first section 621 of the second bracket leg 62 and a second engagement means 629 in a second section 626 of the second bracket leg 62.

Of these two engagement means 624, 629, the second engagement means 629 is configured to assume an inactive position and an active position, of which the active position is shown.

The first engagement means 624 is configured to be received in one receiving structure of the outer side of the frame member 22 in the mounted condition of the mounting bracket 6 on the frame 2 of the roof window 1, and the second engagement means 629 is configured to be received in another receiving structure of the outer side of the frame member 22 in the mounted condition of the mounting bracket 6 on the frame 2 of the roof window 1 in its active position only. This is shown most clearly in FIG. 4, in which the first engagement means 624 is received in a first outer groove 27, and the second engagement means 629 is received in a second outer groove 27b. At least the side frame members 22, 23 each comprises a plurality of receiving structures at an outer side of the respective side frame member, such that at least one of the receiving structures interacts with the mounting bracket 6 in the mounted condition of the roof window 1. The first outer groove 27 and the second outer groove 27b both extend in the longitudinal direction of the side frame member 22 at a distance from each other in the height direction, the first outer groove 27 being located to the exterior of the second outer groove 27b, as seen in the height direction.

To bring the second section 626 with the second engagement means 629 from the position in an aperture 620 in the second bracket leg 62 to a position in which the second section 626 is located substantially in extension of the first section 621, the second section 626 with the second engagement means 629 is connected to the first section 621 via a hinge connection 625, such that the second section 626 is configured to be brought from the inactive position to the active position by rotating the second section 626.

In the embodiment shown, each of the first and second engagement means comprises a flange 624, 629 protruding at substantially right angles from the respective first and second sections 621, 626. Alternative configurations such as discrete spikes are also conceivable.

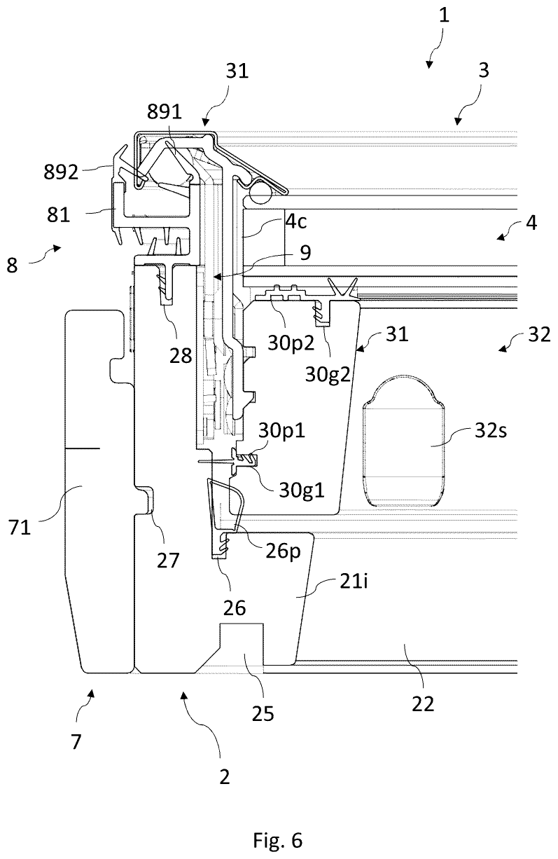

### Hinge Assembly and Coupling Unit—FIGS. 6 to 7 and 22 and 23

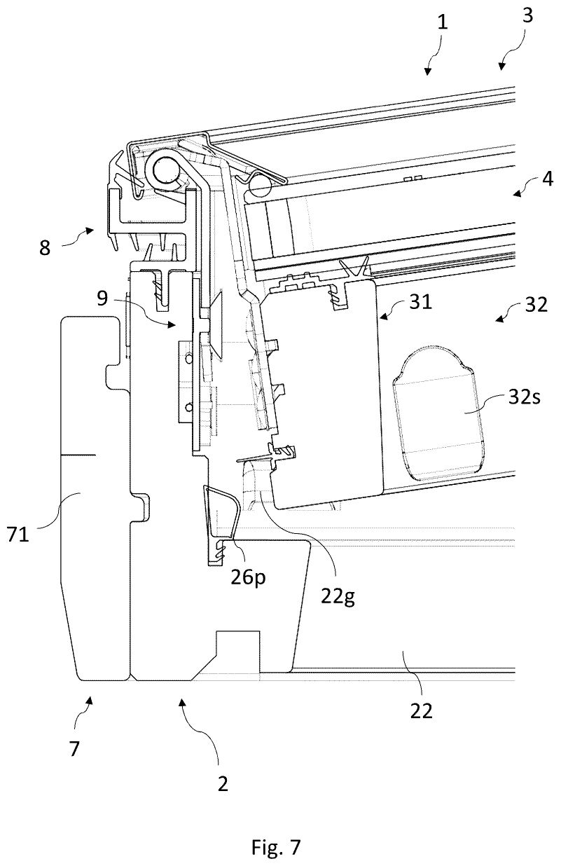

Referring first to FIGS. 6 and 7 it is shown that the roof window 1 furthermore comprises a hinge assembly 9.

The hinge assembly 9 is configured in such a way that it allows the sash 3 to be tophung in a first operational condition corresponding to normal use. That is, during normal use the sash 3 is rotated about a substantially horizontal first hinge axis at or near the top frame member 21 and top sash member 31 between a closed position and an open position.

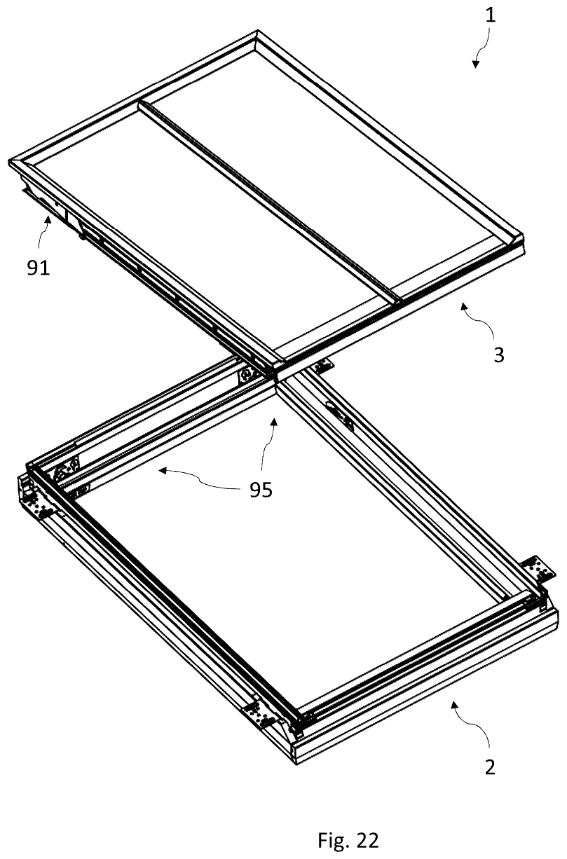

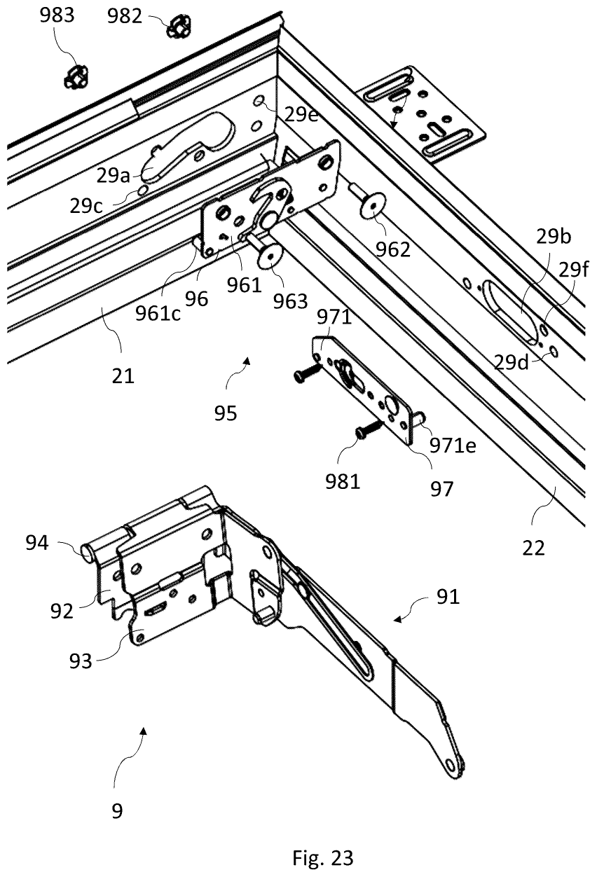

Referring now also to FIGS. 22 and 23, it is seen that the hinge assembly 9 comprises a hinge unit 91 with a frame hinge part 92 connected to or connectable to at least the top frame member 21, a sash hinge part 93 connected to at least the top sash member 31, and a hinge pin 94 connecting the frame hinge part 92 with the sash hinge part 93.

The term “connected to” implies that the component in question is in a condition, state or position in which the component in question is in fact connected to a part, whereas “connectable to” is intended to encompass such conditions, states and positions in which the component in question may be connected to the relevant part, but is not necessarily in connection with the part. In the description of FIGS. 22 and 23, the frame hinge part 92 including any sub-components will be described as being connected to parts of the frame 2.

In the following, a coupling unit 95 of the hinge assembly 9 will be described in some detail. Details of the hinge assembly 9 are described in more detail in Applicant's co-pending patent applications filed on the same date as the present application.

The coupling unit 95 is configured to allow selective coupling of at least the frame hinge part 92 of the hinge unit 91 to the top frame member 21 and optionally to one of the side frame members 22, 23. In the following, the coupling unit 95 will be described as comprising both a top frame coupling plate 96 and a side frame coupling plate 97. Alternative configurations are conceivable.

The top frame coupling plate 96 comprises a base section 961 connected to an inner side of the top frame member 21. The top frame coupling plate 96 is connected to the top frame member 21 by means of a plurality of fastening means including at least one spigot 961c on the base section 961 and two bolt elements functioning also as engagement pins 962, 963. In this case, each engagement pin 962, 963 cooperates with an insert nut 982, 983 on the outer side of the top frame member 21. To accommodate the top frame coupling plate 96, the top frame member 21 comprises a hinge assembly receiving milling 29a and a set of openings 29c, 29e of which openings 29e are through-going openings, or through-holes.

The side frame coupling plate 97 comprises a base section 971 and is connected to the inner side of the side frame member 22 by means of a plurality of fastening means including at least one spigot 971e on the base section 971 and at least one opening (not shown in detail) for fastening means such as screws 981. To receive the side frame coupling plate 97, the side frame member 22 comprises a hinge assembly receiving milling 29b and a set of openings 29d, 29f.

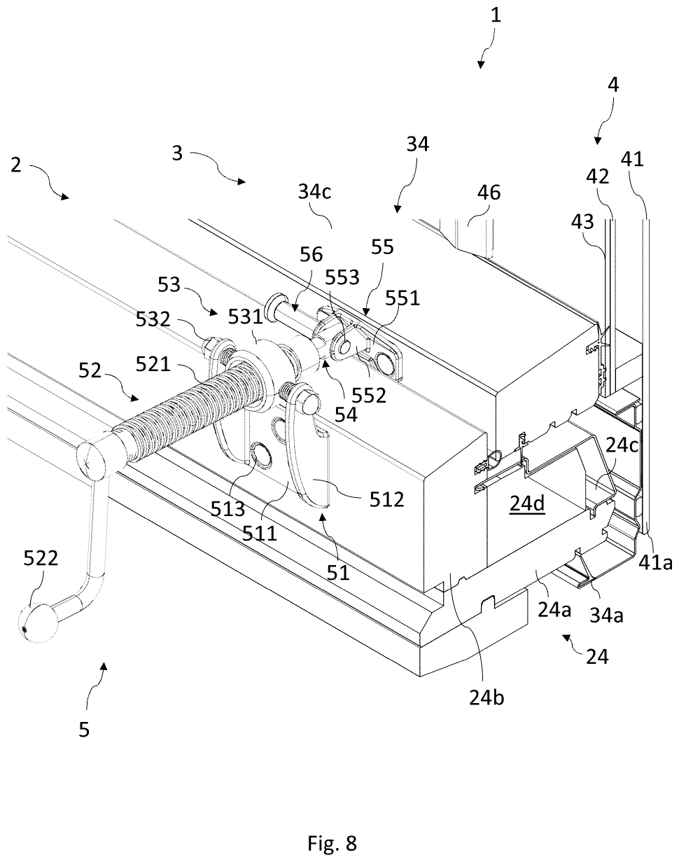

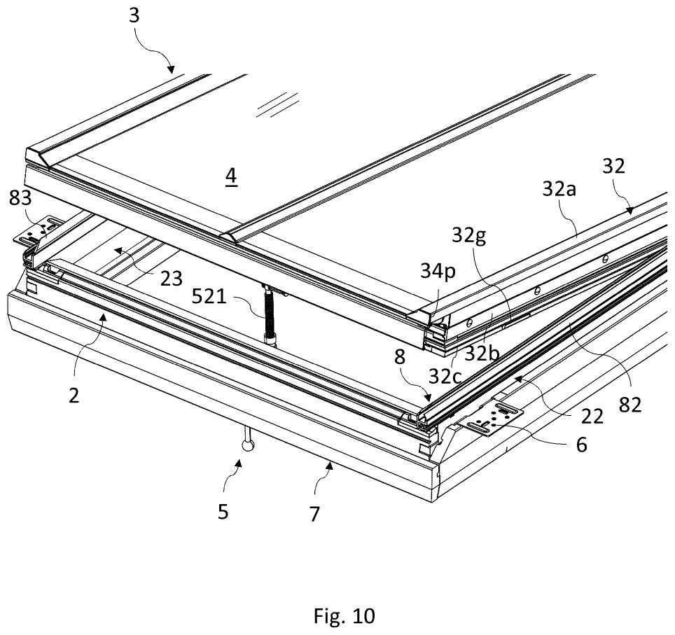

### Operating Assembly—FIGS. 8 and 10

During normal use, i.e. when the roof window 1 has been installed, and a user wishes to put the sash 3 in a ventilating position, the opening, closing and parking may be carried out by the assistance of an operating assembly, for instance as the shown manual handwinder or screwjack constituting the operating assembly 5.

Referring first to FIG. 8, the operating assembly 5 comprises a sash fitting 55, a spindle part 52 with a spindle 521 connected to a socket fitting 51 via a nut part 53, and a handle 522, the sash fitting 55 being connected to the bottom sash member 34 and the socket fitting 51 being connected to the bottom frame member 24 in a mounted condition of the operating assembly such that upon rotation of the spindle part 52 relative to the nut part 53, the bottom sash member 34 is moved relative to the bottom frame member 24.

In the embodiment shown, the roof window 1 may be provided in a supply condition which is suitable for packaging and transportation, the sash fitting 55 is connected to the bottom sash member 34 of the roof window 1 whereas the spindle part 52 with the nut part 53 and the socket fitting 51 are provided separately from the roof window 1.

The nut part 53 comprises a nut ring 531 connected to a set of flanges 512 protruding from a base plate 511 of the socket fitting 51, here by means of a set of bolts 532. Holes 513 are provided in the base plate 511 for mounting the socket part 51 to the bottom frame member 24.

The operating assembly 5 furthermore comprises a split 56 associated to the sash fitting 55, the split 56 being displaceable between an active position in which it is in engagement with a set of openings 553 in a set of flanges 552 protruding from a base plate 551 of the sash fitting 55 and an inactive position to reveal a reception gap between the flanges 552 of the sash fitting 55.

The spindle part 52 comprises an end portion 54 configured to cooperate with the sash fitting 55 in the mounted condition.

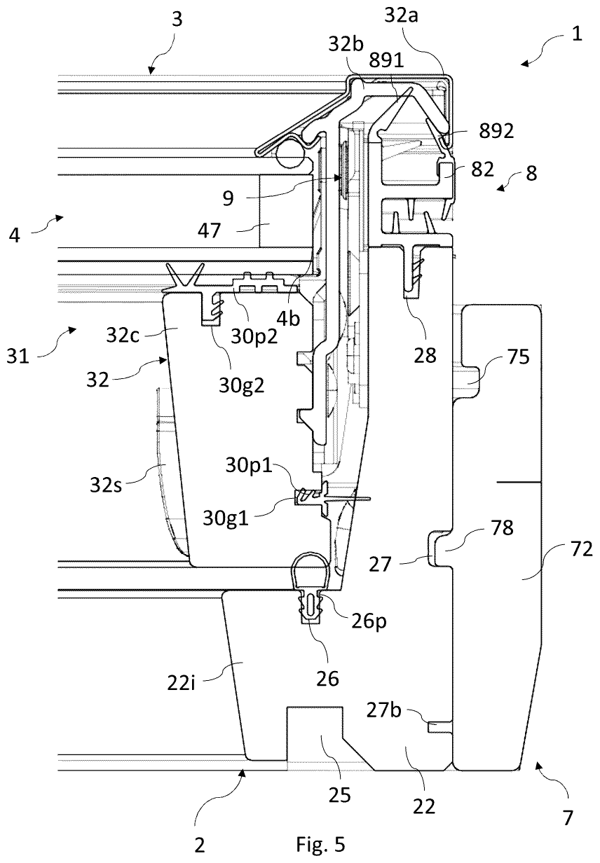

### Sash and Frame Structure—FIGS. 5 to 16

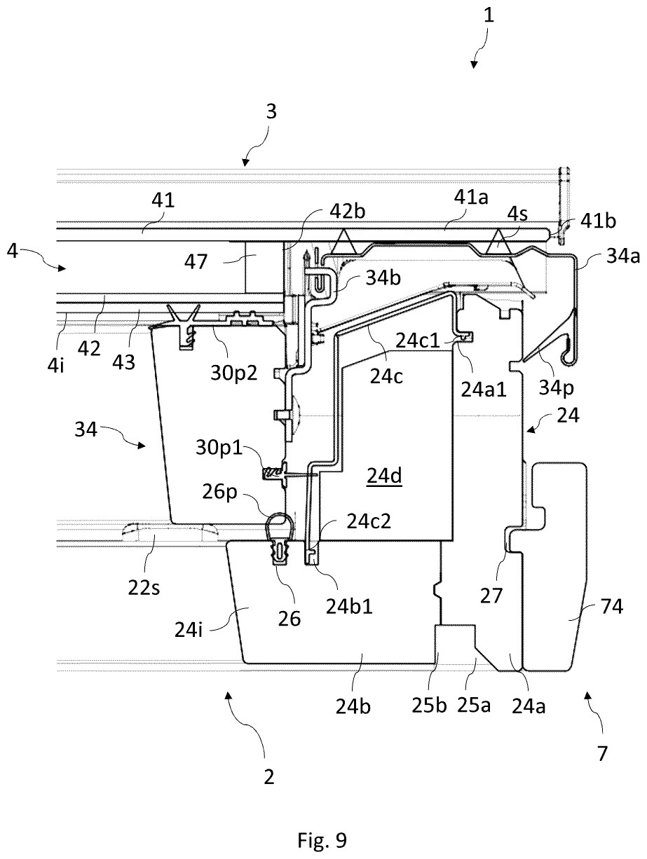

As shown in the cross-sectional view of the bottom part of the roof window 1 in FIGS. 8 and 9, the pane 4 comprises an exterior sheet 41 and at least one interior sheet, here two interior sheets 42, 43 placed in contact with each other. The pane 4 is here a so-called stepped pane in which the exterior sheet 41 comprises an extended portion 41a extending beyond a bottom edge portion 42b of the interior sheets 42, 43 to a bottom edge portion 41b of the exterior sheet 41. Referring now also to FIGS. 4 and 5, showing side and top parts of the roof window 1, respectively, the pane 4 has a common side edge portion 4b—this applies also to the opposite, not-shown side—and a common top edge portion 4c. A spacer 47 is provided between the most exterior interior sheet 42 and the exterior sheet 41 along all edge portions.

Common to all sash members 31, 32, 33, 34 of the sash 3 according to the invention is that each sash member comprises a profile element 31a, 32a, 34a, an inner element 31c, 32c, 34c and an intermediate element 31b, 32b, 34b. Although not indicated, the side sash member 33 not shown in cross-section has a similar configuration as the shown side sash member 32.

The intermediate element 31b, 32b, 34b of the respective sash member 31, 32, 33, 34 forms a connection between the profile element 31a, 32a, 34a and the inner element 31c, 32c, 34c of the sash member 31, 32, 33, 34 in question. The intermediate elements 31b, 32b, 34b of the sash members 31, 32, 33, 34 may in principle be formed in the same way for all four sash members, or be formed with individual properties. Typically, the two side sash members 32, 33 of the sash 3 will be designed with equal properties though.

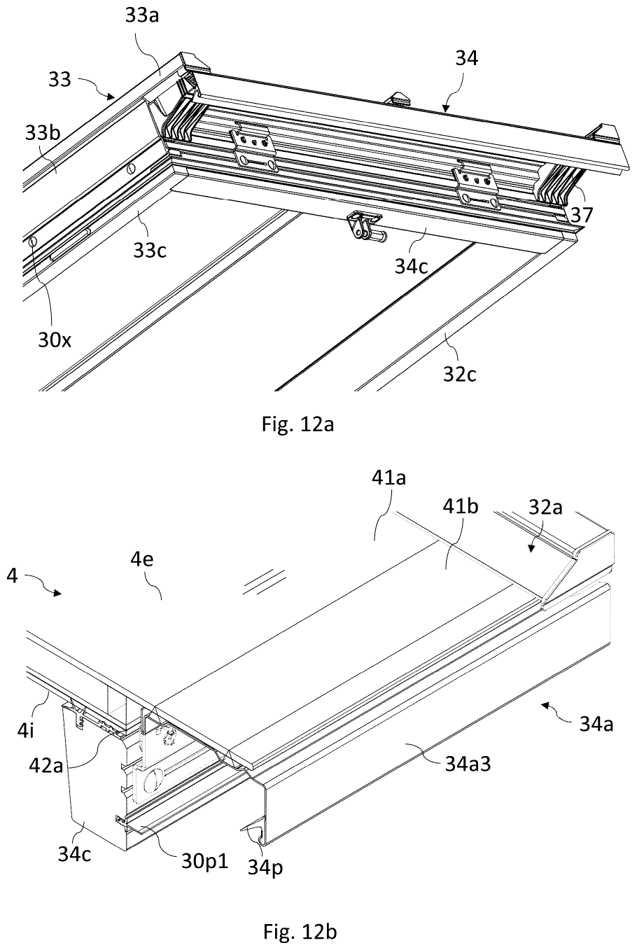

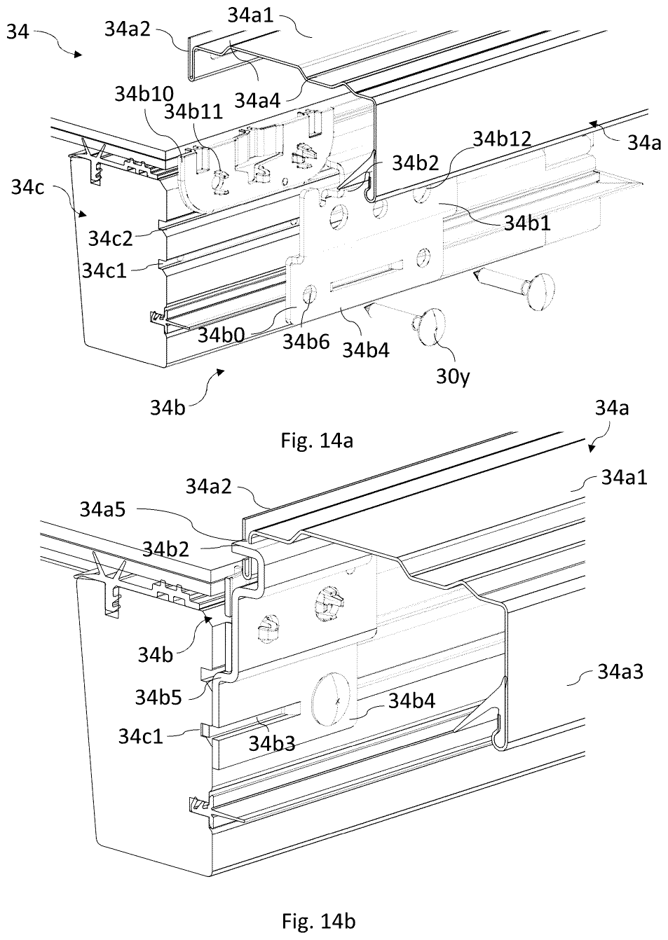

Referring also to FIG. 12a, the intermediate elements 31b, 32b, 33b of the top sash member 31 and the two side sash members 32, 33, in the embodiment shown, are formed as a set of longitudinal profiles while the intermediate element 34b of the bottom sash member 34 comprises a set of separate fittings described in greater detail in connection with FIGS. 14a-b. Details of the respective intermediate elements 31b, 32b, 33b, 34b will be described below.

The inner elements 31c, 32c, 33c, 34c of the sash members 31, 32, 33, 34 form a coherent inner element sash structure supporting an interior edge portion of the pane 4. That is, edge portions of the pane 4 partly overlap the inner elements 31c, 32c, 33c, 34c as seen from the interior. In this way, the top edge portion 4c, the side edge portion 4b, and the opposite side edge portion, and the bottom edge portion 42b of the interior sheet 42 are all located on the outer side of the coherent sash structure provided by the inner elements such that any spacers 47 and other elements present along the edge portions of the pane 4 are hidden from view by the inner elements 31c, 32c, 33c, 34c and are thus not visible from the interior of the building. The inner elements 31c, 32c, 33c, 34c of the sash members 31, 32, 33, 34 may have a substantially identical cross-sections and be formed by any suitable material, for instance wood, joined in mortise joints at the corners. It is also conceivable to form the inner element structure as a fully coherent structure, for instance by moulding.

As will also be described in further detail in connection with the embodiment below, the profile elements 31a, 32a, 33a, 34a of the sash members 31, 32, 33, 34 are located along respective exterior edge portions of the pane 4, and the intermediate element 31b, 32b, 33b, 34b of each sash member 31, 32, 33, 34 comprises engagement means 32b3, 34b3 configured to form a structural connection with the inner element 32c, 34c in one of at least two distinct positions in the height direction.

Also indicated in FIGS. 5 and 6 is a hinge assembly 9 present in a gap between the top sash member 31 and the top frame member 21, and between the side sash member 32 and the side frame member 22, by which the sash 3 is connected to the frame 2 to provide a tophung hinge connection.

Regarding the frame 2 of the roof window 1, each frame member 21, 22, 23, 24 comprises a plurality of receiving structures at an interior, exterior, inner and/or outer side of the respective frame member. Each receiving structure is configured to interact with auxiliary equipment in an assembled condition of the frame 2.

In the embodiment shown, the top frame member 21 and the two side frame members 22, 23 have substantially identical cross-sections.

Referring particularly to FIGS. 8 and 9, the bottom frame member 24 comprises an outer piece 24a and a separate inner piece 24b. The outer piece 24a and the separate inner piece 24b may be formed by the same material as the top frame member 21 and the side frame members 22, 23, for instance wood, or as a composite component comprising plywood and other materials.

A further feature of the roof window 1 in the shown embodiment is that the frame 2 comprises at least one releasable component configured to allow replacement with a different set of components to change the functionality of the roof window 1.

In the embodiment shown, one such releasable component comprises a cover 24c releasably connected to remaining components of the bottom frame member 24 and defining a cavity relative to the remaining components of the bottom frame member 24. The cover 24c may be formed by any suitable material, for instance a profile element of a plastic or metal material.

Here, where the bottom frame member 24 comprises the outer piece 24a and the separate inner piece 24b, the cavity defined by the cover 24c is defined by the inner side of the outer piece 24a in the outwards direction and mainly by the exterior side of the separate inner piece 24b towards the interior.

To obtain the releasable connection, edge portions 24c1, 24c2 of the cover 24c are received in receiving grooves in the bottom frame member 24, specifically in one receiving groove 24a1 in the outer piece 24a and one receiving groove 24b1 in the separate inner piece 24b.

In the embodiment shown, in which the roof window 1 is prepared for manual operation by means of the operating assembly 5, an insulating piece 24d is accommodated in the cavity defined by the cover 24c.

In order to change the functionality of the roof window 1, the cavity defined by the cover 24c is configured to receive an electrical operator (not shown) and the cover 24c is configured to be replaced by a different cover (not shown) allowing operating means of the electrical operator to be connected to the sash 3.

It is also conceivable to allow the sash fitting 55 connected to the bottom sash member 34 to be selectively connected to such an electrical operator in which case the sash fitting 55 is simply reused for the operating means of the electrical operator.

Likewise, it is conceivable to provide the roof window 1 in a condition in which the bottom frame member 24 comprises a dummy element configured to be replaced by the socket fitting 51 of the operating assembly 5.

Correspondingly, if the roof window 1 were provided in a basic form with a different hinge than the hinge assembly 9 described in the above embodiments, it would also be conceivable to use blind plates to cover the hinge assembly receiving millings 29a, 29b to allow replacement of the previous hinge with the hinge assembly 9.

A first receiving structure comprises a lining groove 25 in an interior side of each frame member 21, 22, 23, 24. The lining groove 25 is configured to interact with a set of interior lining panels. Such lining panels typically form the transition between the roof window 1 and in interior wall. In the bottom frame member 24, a first groove portion 25a is provided in the outer piece 24a and a second groove portion 25b in the separate inner piece 24b. In the assembled condition of the frame 2, the first and second groove portions 25a, 25b form the lining groove 25.

In the embodiment shown, each frame member 21, 22, 23, 24 comprises an inwards protruding portion 21i, 22i, 24i at least partly overlapping the corresponding sash member 31, 32, 33, 34, as seen from the interior. This is made possible, since all parts of the sash 3 move towards the exterior when opening the sash 3 relative to the frame 2.

A second receiving structure comprises a sealing groove 26 in an exterior side of the inwards protruding portion 21i, 22i, 24i. The sealing groove 26 is configured to interact with a frame sealing profile 26p.

A third receiving structure comprises an first outer groove 27 in an outer side of the frame member 21, 22, 23, 24. The first outer groove 27 is configured to interact with a respective piece 71, 72, 73, 74 of the insulating frame 7. The interaction may take place by introducing a longitudinal protrusion 78 of the insulating frame piece into the groove, or to locate separate fastening means correctly.

Taking again the perspective as seen from a user from the interior of the building, in the roof of which the roof window 1 is installed, it is also noted that the inwards protruding portion 21i, 22i, 24i of each frame member 21, 22, 23, 24 has an inwards facing surface which together form a coherent inwards facing surface. As indicated, this appearance mimics a corresponding coherent inwards facing surface of the sash 3.

A fourth receiving structure comprises an interface unit groove 28 in an exterior side of the top frame member 21 and two side frame members 22, 23. This interface unit groove 28 interacts with a respective top and side element 81, 82, 83 of an interface unit 8, the function of which will be described further below.

Further details visible in the drawings include guiding elements 22g (see FIG. 7) and 32g (see FIG. 10), which ascertain that the sash 3 is aligned relative to the frame 2 when closing the sash such that any skewness occurring in the open position of the sash 3 is eliminated. A screening mounting bracket 32s is visible in FIG. 8, by which it is possible to install an interior screening device (not shown) in the sash 3 to provide screening of the pane 4. An abutment element 22s provides a stop for the bottom sash member 34 during closing.

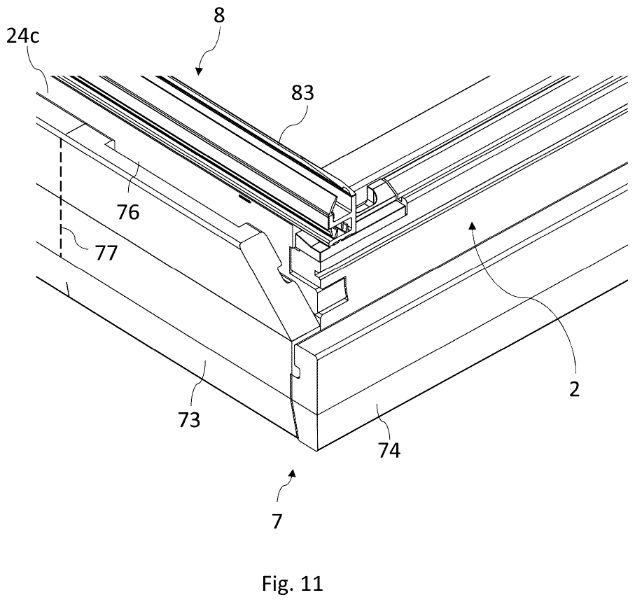

Details of the insulating frame 7 are also shown in these figures; as mentioned in the above, the insulation frame 7 includes top piece 71, side pieces 72, 73, and bottom piece 74. In the embodiments shown, each such insulation frame piece comprises protrusion 78 to be received in the outer side of the respective frame member, and an indentation 75 to interact with auxiliary equipment in the form of an underroof collar described in more detail in Applicant's co-pending patent applications filed on the same date as the present application. With particular reference to FIG. 11, a recess 76 is shown which makes place for the mounting bracket 6 to be mounted on the side frame member 23 of the frame 2, and a folding line 77 which allows folding back of part of the side piece 73 of the insulating frame 7 to allow access to the outer side of the side frame member 23. At least the side pieces 72, 73 of the insulating frame 7 are provided with such recesses 76 and folding lines 77 at or near the location of the intended positions of the mounting brackets 6 of the set of mounting brackets supplied with the roof window 1. The insulating frame 1 may in principle be made from any material with suitable thermal insulating properties. It is presently preferred that a foam material be used, for instance polyethylene foam.

### Intermediate Elements—FIGS. 5 to 16

Turning now to the description of the connection between the elements of the sash 3, the engagement between the intermediate elements 31b, 32b and 33b of the top sash member 31 and the two side sash members 32, 33 and the respective inner element 31c, 32c, 33c will be described first.

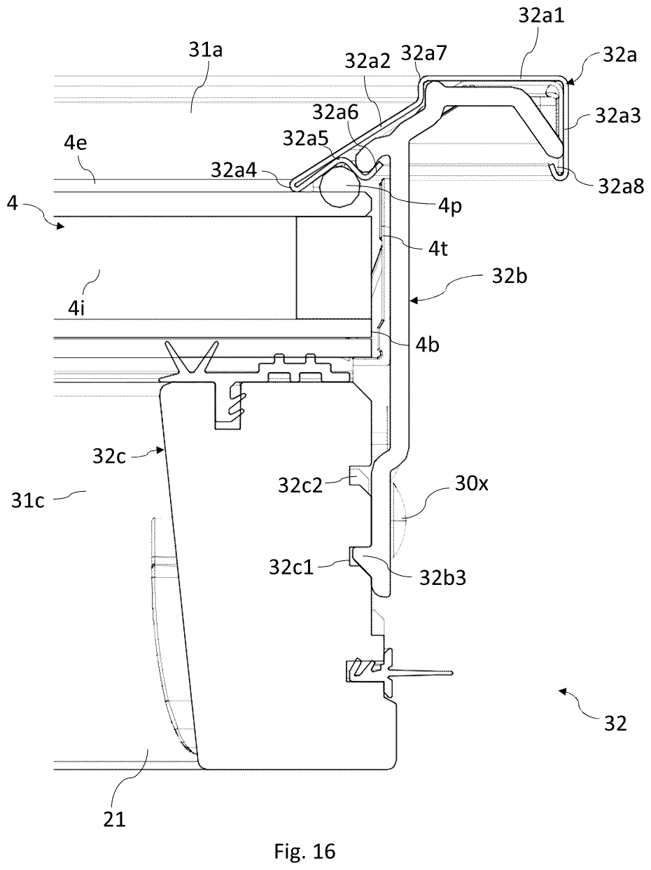

With particular reference to FIG. 16, an outer side of each inner element, here as shown the inner element 32c of the side sash member 32, is provided with reception means configured to receive the engagement means of the intermediate element 32b of the side sash member 32.

In the embodiment shown, the reception means comprises two longitudinally extending grooves 32c1, 32c2 at a distance from each other in the height direction, the grooves being open in an outwards direction of the roof window 1.

In the embodiment shown, the longitudinal profiles forming the intermediate elements 31b, 32b, 33b have a uniform cross-section and may in principle be cut from one and the same profile length. It is preferred that the longitudinal profiles are formed by a continuous moulding process, such as extrusion or pultrusion. Specifically the profiles are formed by pultrusion of a composite material incorporating resin and glass fibre.

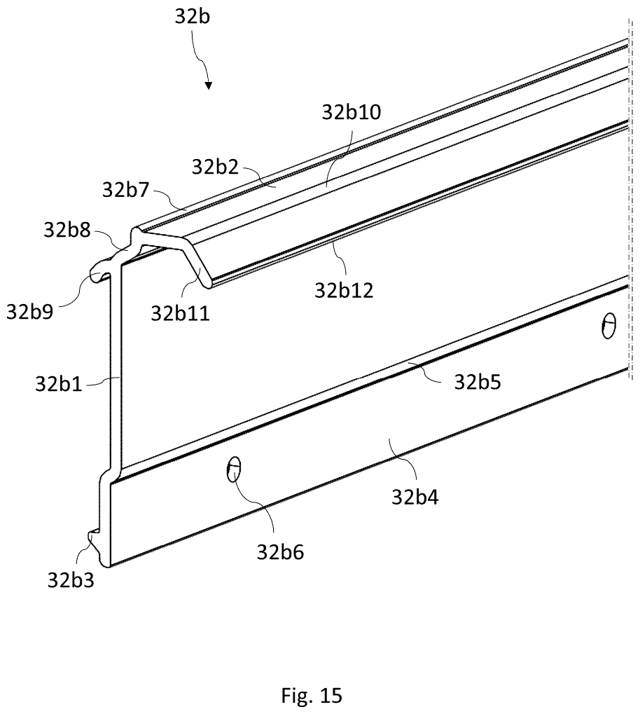

Thus, only one of these intermediate elements will be described in detail, namely intermediate element 32b. Referring now to FIG. 15, the intermediate element 32b comprises a base portion 32b1 extending substantially in the height direction in the assembled condition of the sash 3 and a head portion 32b2 extending at an angle to the base portion 32b1. The base portion 32b1 is provided with the engagement means on a surface facing inwards in the assembled condition, facing an outer surface of the inner element 32c, as shown in FIG. 16. The position, location and length of the individual intermediate elements 31b, 32b and 33b appear also from FIGS. 3, 4, 5, 10 and 12a.

In the embodiment shown, the engagement means of the base portion 32b1 of the intermediate element 32b comprises a protruding portion formed as a flange 32b3 extending throughout the length of the profile and configured to engage with a selective one groove 32c1, 32c2 of the inner element 32c of the side sash member 32.

The base portion 32b1 of each intermediate element 32b comprises a stepped section 32b4, which is offset in the inwards direction by an offsetting bend 32b5 relative to the remaining section of the base portion 32b1. The engagement means, here the flange 32b3, is provided in the stepped section 32b4.

Additional fastening means 30x (cf. FIGS. 12a and 16) are provided to fasten the intermediate element or elements 32b to the inner element 32c of the side sash member 32. In order to receive the additional fastening means 30x, the base portion 32b1 of the intermediate element 32b comprises openings 32b6 configured to receive the additional fastening means 30x, namely in the stepped section 32b4.

Turning now in particular to FIGS. 14a and 14b, the connection between the intermediate element 34b and the inner element 34c of the bottom sash member 34 will be described in detail.

Just as the intermediate elements 31b, 32b, 33b described in the above, the intermediate element 34b comprises a base portion 34b1 extending substantially in the height direction and a head portion 34b2 extending at an angle to the base portion 34b1. The base portion 34b1 is provided with the engagement means 34b3 on an inner surface, facing an outer surface of the inner element 34c. The engagement means of the base portion 34b1 comprises a protruding portion 34b3 to engage with a selective one groove 34c1, 34c2 of the inner element 34c of the bottom sash member 34. Additional fastening means 30y are provided to fasten the intermediate element 34b to the inner element 34c of the bottom sash member 34, in openings 34b6 in stepped section 34b4, which is offset in the inwards direction by offsetting bend 34b5 relative to the remaining section of the base portion 34b1.

In the embodiment shown, the intermediate element 34b of the bottom sash member 34 comprises a set of fittings. Two such sets may be provided along the length of the bottom sash member 34.

Each set of fittings comprises a connecting fitting provided with the engagement means configured to form a structural connection with the inner element 34c in one of at least two distinct positions in the height direction. The connecting fitting comprises a first fitting part 34b0 and a second fitting part 34b10. The first fitting part 34b0 comprises the engagement means and the second fitting part 34b10 is configured to be connected to the first fitting part 34b0 to function as a spacer between the outer surface of the inner element 34c of the bottom sash member 34 and the first fitting part 34b0. To connect the first and second fitting parts 34b0, 34b10 with each other, the second fitting part 34b10 is provided with at least one resilient hook 34b11 configured to interact with a corresponding opening 34b12 in the first fitting part 34b0. The head portion 34b2 of the intermediate element 34b of the bottom sash member 34 is received in a slit 34a5 of an inner portion 34a2 of the profile element 34a of the bottom sash member 34 in the assembled condition of the sash 3.

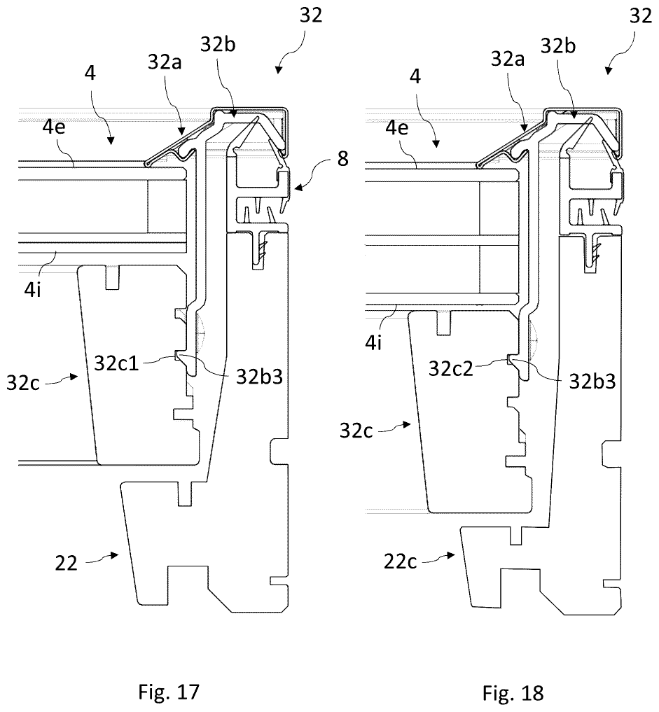

### Comparison Embodiments—FIGS. 17 and 18

Turning now to FIGS. 17 and 18, showing a simplified overview of the main components of the side sash member 32, it is seen how the same components of the sash 3 may accommodate two different thicknesses of the pane 4. This is carried out by changing the position of the engagement means of the intermediate element 32b from the first groove 32c1 to the second groove 32c2. This will require a slightly adapted side frame member 22c. The intermediate elements 31b, 33b, 34b at the other sash members 31, 33, 34 are moved similarly.

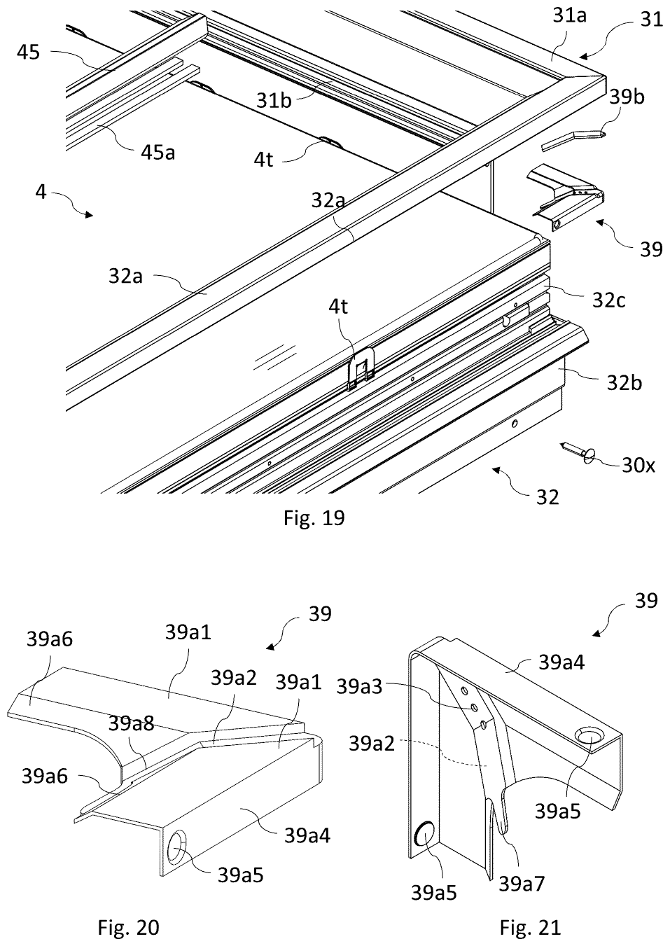

### Profile Elements—FIGS. 19 to 21

Focus will now be on the profile elements of the sash 3. The general configuration of the profile elements 31a, 32a and 33a of the top and side sash members 31, 32, 33 is shown in the perspective views of FIGS. 3 to 6 and 10 while details are shown in the cross-sectional view of FIG. 16. The profile element 34a of the bottom sash member 34 is shown most clearly in FIGS. 12a to 14b.

Corresponding to the above, only the profile element 32a of the side sash member 32 will be described in representation of the longitudinal profiles of the top sash member 31 and the two side sash members 32, 33, since in the embodiment shown, these profile elements are formed as a set of longitudinal profiles of substantially uniform cross-section.

The details common to all profile elements 31a, 32a, 33a, 34a are as follows:

Each profile element 32a, 34a comprises a head portion 32a1, 34a1 and an adjoining outer portion 32a3, 34a3.

The head portion 32a1, 34a1 is substantially parallel to the plane of the roof window 1 in the assembled condition of the roof window 1, and the adjoining outer portion 32a3, 34a3 is substantially perpendicular to the head portion 32a1, 34a1.

However, the head portion 32a1 of the profile element 32a of each of the top and side sash members 31, 32, 33 is located on the exterior side of the exterior pane surface 4e, and on the outer side of the side edge portion 4b and the top edge portion 4c of the pane 4, whereas the head portion 34a1 of the profile element 34a of the bottom sash member 34 is located on the interior side of the extended portion 41a of the exterior sheet 41 of the pane 4.

The profile element 32a of the side sash member 32 and the profile element 34a of the bottom sash member 34 are thus separated by a layer of glass; nevertheless, an overlap is provided by selecting a length of the profile elements 32a, 33a of the two side sash members 32, 33 to substantially correspond to or slightly exceed the distance between the top edge portion 4c of the pane 4 and the bottom edge portion 41b of the exterior sheet 41 of the pane 4. The length of the profile element 34a of the bottom sash member 34 is suitably selected to extend substantially to the side edge portion 4b of the pane 4.

The length of the profile element 31a of the top sash member 31 is chosen in accordance with the dimensions of the pane 4 and the desired manner of joining the profile element 31a to the profile elements 32a, 33a. In the embodiment shown, the longitudinal profiles form mitred joints between the profile element 31a of the top sash member 31 and the respective profile element 32a, 33a of the side sash members 32, 33 in the assembled condition of the sash 3, see FIG. 19.

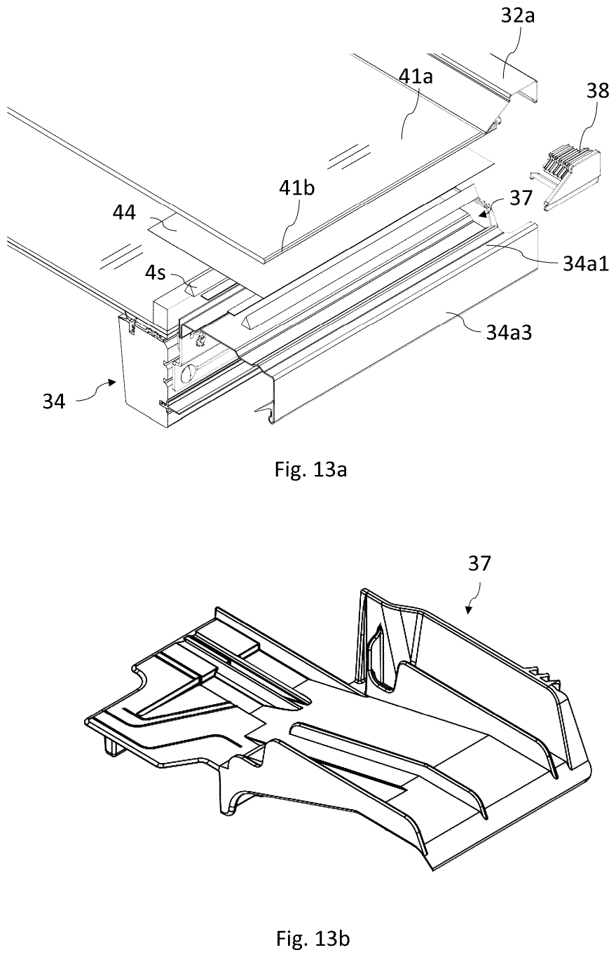

Also visible in FIGS. 12a to 13b are an end plug 38 which closes off the profile element 32a of the side sash member 32. The end plug 38 is provided with friction-increasing ribs and a snap arm, not described in detail. The glazing bar 45 is provided with a counterpart end plug. Furthermore, a trailing element 37 is provided to drain any condensed water out to a profile element sealing 34p.

To ensure a tight joint at the mitred joints, a corner key 39 is provided at each mitred joint, see FIGS. 19-21. During manufacture, a sealant 39b is suitably applied as will be described in further detail below with particular reference to FIGS. 19 to 21.

The corner key 39 has a generally L-shaped configuration with two perpendicular legs 39a1 divided by a channel 39a2. In the channel 39a2, a set of primary openings 39a3 is provided.

Furthermore, each leg 39a1 is adjoined by a depending skirt 39a4 on a first side. Here, a secondary opening 39a5 is provided.

In order to fit the profile of the profile elements 31a, 32a, 33a, each leg 39a1 is adjoined by an inclined section 39a6 on a second side.

As shown in FIGS. 20 and 21, the channel 39a2 ends in a tongue 39a7, optionally adjoining an inclined channel section 39a8.

The profile elements 31a, 32a, 33a are suitably configured to receive the pane 4 in an upside-down position, i.e. with the respective head portions 32a1 facing a substrate such as an assembly table. This step of the assembly of the sash 3 may take place after the intermediate elements 31b, 32b, 33b have been introduced into the respective profile elements 31a, 32a, 33a. Also visible in FIGS. 16 and 19, are pane clips 4t, which are placed at suitable distances from each other along the top edge portion 4c and side edge portions 4b of the pane 4. In the embodiment shown, the interaction between the main components of the sash 3 is defined by the following configuration of the components:

Each of the longitudinal profiles forming the profile elements 31a, 32a, 33a of the top sash member 31 and the two side sash members 32, 33 comprises an inner portion 32a2 adjoining the head portion 32a1. The dimensions are chosen such that the inner portion 32a2 overlaps the pane 4 in the assembled condition of the sash 3.

The head portion 32a1 of each profile element 31a, 32a, 33a is configured to protrude to the exterior relative to the exterior surface of the pane 4e in the assembled condition of the sash 3.

The inner portion 32a2 is inclined from the head portion 32a1 relative to the head portion 32a1 and extends inwards and to the interior, towards the exterior surface of the pane 4e in the assembled condition of the sash 3.

The inner portion 32a2 is adjoined by a first bend 32a4 configured to be located at or near the exterior surface of the pane 4e.

A second bend 32a5 is provided as shown in for example FIG. 16. The second bend 32a5 has as its function to accommodate a sealing 4p relative to the exterior surface of the pane 4e.

A third bend 32a6 is also provided, said third bend 32a6 being configured to accommodate an inner edge portion 32b9 of the intermediate element 32b relative to an interior side of the inner portion 32a2. For a detailed overview of the intermediate element 32b, confer FIG. 15.

A transition portion 32a7 is provided between the head portion 32a1 and the inner portion 32a2. The transition portion 32a7 is configured to accommodate a ridge portion 32b7 of the intermediate element 32b.

A fourth bend 32a8 is provided adjacent the outer portion 32a3 of the profile element 32a. The fourth bend 32a8 is configured to accommodate an outer edge portion 32b12 of the intermediate element 32b.

The inner portion 32a2 of the profile element 32a is configured to be located opposite an inner inclined portion 32b8 of the intermediate element 32b in the assembled condition of the sash 3.

Finally, the outer edge portion 32b12 of the intermediate element 32b is associated with the head portion 32b2 of the intermediate element 32b via an outer inclined portion 32b11 and a bend 32b10.

All in all, the configuration of the described embodiment makes it possible to provide a secure engagement between the intermediate elements 31b, 32b, 33b and the profile elements 31a, 32a, 33a.

The length of the intermediate elements 32b, 33b of the side sash members 32, 33 may be chosen slightly shorter than the associated profile elements 32a, 33a.

At the bottom sash member 34, the head portion 34a1 of the profile element 34a is provided with at least one longitudinally extending groove 34a4 to receive a respective sealing strip 4s. These sealing strips 4s may be formed by silicone to form an adhesive connection between the profile element 34a and the extended portion 41a of the exterior sheet 41 of the pane 4. A masking 44 may be provided at the extended portion 41a on in interior side of the exterior sheet 41.

As described in the above, the intermediate element 31b, 32b, 33b, 34b of each sash member 31, 32, 33, 34 comprises engagement means 32b3, 34b3 configured to form a structural connection with the inner element 31c, 32c, 33c, 34c. To secure the intermediate element 34b of the bottom sash member 34 also to the profile element 34a, the head portion 34b2 of the intermediate element 34b is configured to be received in a slit 34a5 of an inner portion 34a2 of the profile element 34a of the bottom sash member 34 in the assembled condition of the sash 3, see FIGS. 14a-b. To increase the strength of the inner portion 34a2, this portion may be formed as a double-layer, folded portion.

The manufacture of the sash 3 may in principle take place in any suitable manner. In the following, one presently preferred method will be described:

In a first step, a set of three longitudinal profiles is provided. The longitudinal profiles may for instance be formed a single profile length of an extruded material such as metal, for instance aluminium. Other materials and manufacturing processes are conceivable, including roll forming of steel or other metal, or of a composite material.

Secondly, mitre shapes are formed at mutually facing ends of the longitudinal profiles. If the longitudinal profiles are formed from a single length, and if convenient, the mitre shapes may be formed in a coherent length by aptly formed incisions to form inner corners at the intersection between the top and the sides.

A pane of suitable dimensions is provided, for instance as described in the above.

The sets of four inner elements and four intermediate elements are provided, for instance as described in the above.

The longitudinal profiles are now placed in an upside-down position on an assembly table to form a profile element frame structure constituting three sides of a rectangle. This typically takes place by guiding elements fixable to the assembly table corresponding to the outer circumference of the sash.

The pane is placed within the profile element frame structure, and the profile element structure is connected to the inner elements, optionally via the intermediate elements, to form the sash. During this procedure, the intermediate elements at the top and sides are typically inserted into the counterpart profile elements. The inner elements may as described above be connected to each other to form an inner element frame structure, which is placed on the pane, following which the intermediate elements are connected to the respective inner elements.

Referring briefly back to FIGS. 19 to 21, a set of two corner keys 39 is advantageously provided placed within the longitudinal profile element s 31a, 32a, 33a at the mutually facing mitred ends before placing the pane 4 within the profile element frame structure. Sealant 39b is preferably applied to each corner key 39. During assembly, it is ensured that the sealant 39b is able to flow through the primary openings 39a3 of the corner key 39 such that the sealant 39b is distributed.

In the embodiment shown, each corner key 39 is configured to be mechanically connected to the respective adjacent profile elements 31a, 32a, 33a. This may take place by clinching, for instance by TOX® technology.

In embodiments in which the roof window 1 comprises one or more glazing bars, such as glazing bar 45, the glazing bar or bars is/are aligned on the assembly table before placing the pane 4 within the profile element frame structure. The glazing bar 45 is provided with one or more adhesive strips 45a to fasten to the exterior surface 4e of the pane 4.

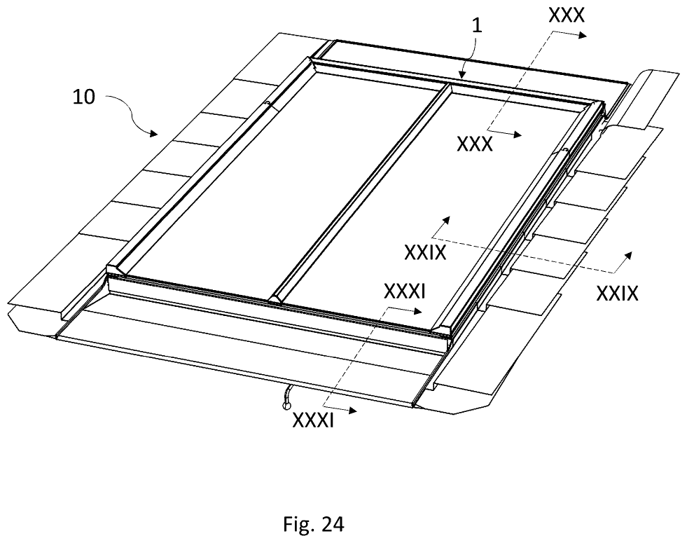

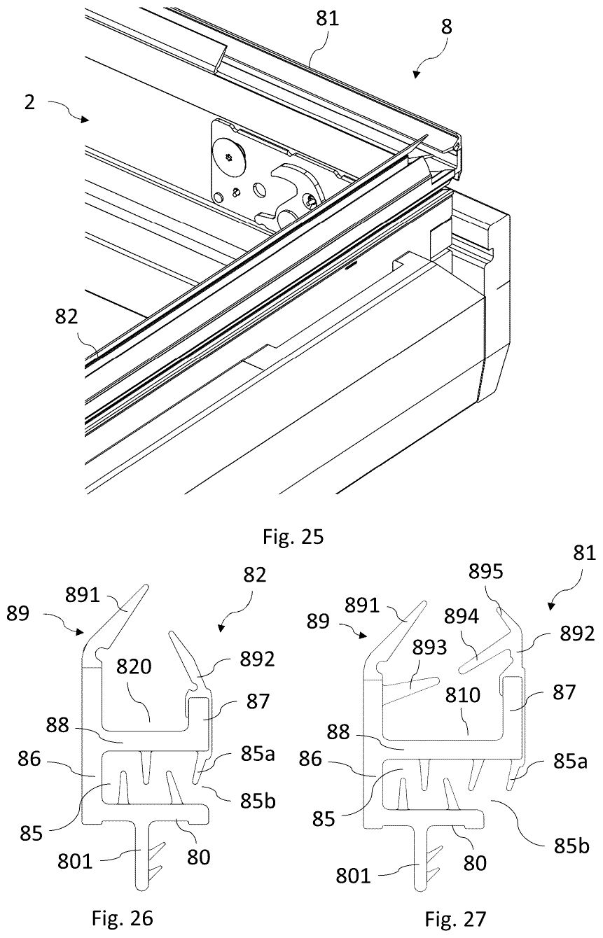

### Sealing Assembly and Interface Unit—FIGS. 24 to 36

Referring now in particular to FIGS. 24 to 29a, an embodiment is shown in which the roof window 1 is provided with a covering assembly 10. Details of the covering assembly 10 generally comprising a flashing assembly and any other auxiliary equipment are described in more detail in Applicant's co-pending patent applications filed on the same date as the present application.

In the following, a sealing assembly of the roof window 1 will be described. Some details of the sealing assembly have been described in the above as well.

The sealing assembly generally comprises a set of sealing profiles.

In the embodiment shown, sealing between the sash 3 and the frame 2 is provided by an exterior sealing plane, an intermediate sealing plane and an interior sealing plane. Reference is also made to the cross-sectional views of the top, side and bottom of the roof window 1 shown and described in the above.

The interior sealing plane comprises the frame sealing profile 26p provided in the exterior side of each frame member 21, 22, 23, 24 and interacts with the interior side of the respective sash member 31, 32, 33, 34. The sash sealing profile 30p1 is provided in sash sealing groove 30g1.

At the bottom side, the intermediate sealing plane comprises the sash sealing profile 30p1 provided in the outer side of each sash member 31, 32, 33, 34 and interacts with the inner side of the respective frame member 21, 22, 23, 24.

The exterior sealing plane is provided in that the profile element sealing 34p on the profile element 34a of the bottom sash member 34 is in contact with the outer side of the bottom frame member 34 in the closed position of the sash 3.

At the top and sides, the exterior sealing plane is defined by the interface elements 81, 82, 83. Referring in particular to FIGS. 26 and 27, the similarities and differences between the top interface element 81 and the side interface elements, here represented by interface element 82, in the embodiment shown will be described:

Each interface element 81, 82 comprises a base portion 80 with an anchor section 801, an inner leg 86, an outer leg 87, a flange 88 and a sealing portion 89. The anchor section 801 of the base portion 80 is received in the interface unit groove 28 in the assembled condition of the roof window 1. The sealing portion 89 faces to the exterior and interacts with the top sash member 31 and side sash members 32, 33 during opening and closing of the sash 3 and in the closed position of the sash 3.

Together, the inner leg 86, the outer leg 87, and the flange 88 form a channel 810, 820 in the top interface element 81 and the side interface element 82. A corresponding channel is formed in the other side interface element 83. In this way, water emanating from rain or other precipitation may be guided from the channel 810 in the top interface element 81 to the channels 820 in the side interface elements 82, 83 and further out to the covering assembly 10 (not shown in detail).

Common to both the top interface element 81 and the side interface element 82 in the embodiment shown is that the sealing portion 89 comprises an inner sealing lip 891 and an outer sealing lip 892. The inner sealing lip 891 of both the top interface element 81 and of the side interface element 82 is provided sufficiently inwards that the inner sealing lip 891 interacts with the interior of the top sash member 31 and the side sash member 32, cf. FIGS. 6 and 5; however the outer sealing lip 892 of the top interface element 81 is located on the outer side of the top sash member 31. In the embodiment shown, this is due to the fact that the flange 88 of the top interface element 8 is longer than the counterpart flange of the side interface element 82. It is noted that while at least the sealing portion 89 of each interface element 81, 82, 83 is formed to be resilient, i.e. as is customary in sealings, the sealing portion 89 is able to be deformed when coming into abutment with another component and then spring back when relaxing, this is not reflected in the figures since they generally show elements in their undeformed condition. In general, at least the sealing portion 89 has different properties than at least the base portion 80. This may be provided by co-extrusion or co-moulding of two (or more) different materials.

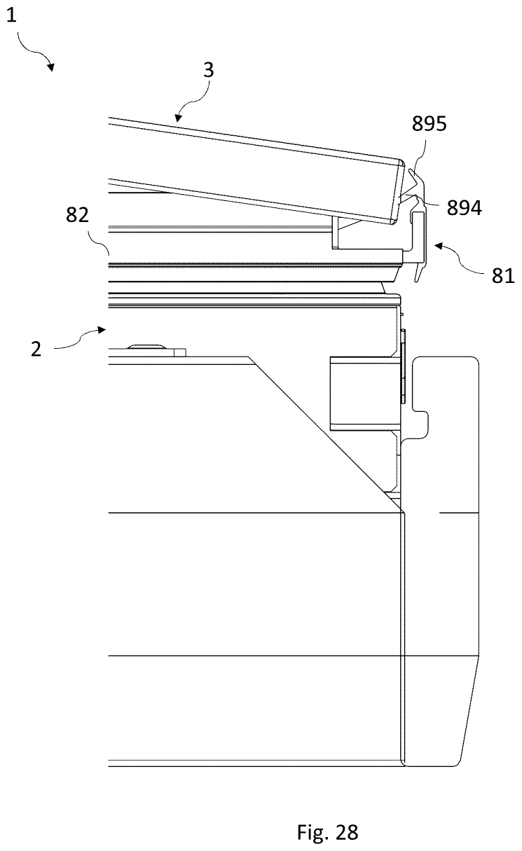

To ensure a tight interaction at the top of the roof window 1, the top interface element 81 comprises an additional inner sealing lip 893, a first additional outer sealing lip 894 and a second additional outer sealing lip 895, cf. also FIG. 28.

In the embodiment shown, the interface elements 81, 82, 83 furthermore allow interaction with the covering assembly 10 in that the base portion 80, inner leg 86 and flange 88 form a flashing reception groove 85. The flashing reception groove 85 has a groove opening 85b and is provided with a number of protrusions 85a.

The sealing assembly furthermore comprises a pane sealing 30p2. received in pane sealing groove 30g2 It is noted that the pane sealing 30p2 remains stationary relative to the sash 3.

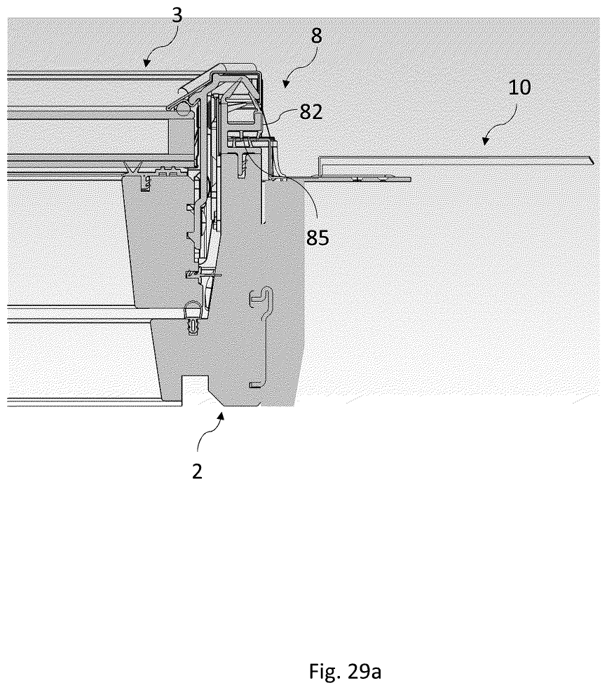

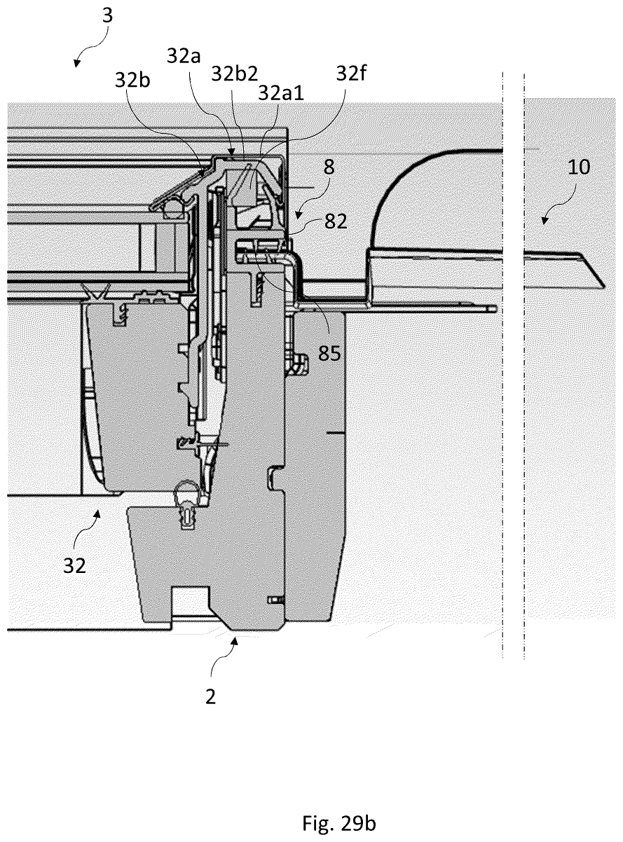

Referring now to FIGS. 29b to 36, details of alternative embodiments will be described. Only differences relative to the above-mentioned embodiment will be described in detail.

In FIG. 29b, a foam element 32f is shown present in the sash side member 32. A similar foam element may be present in the opposite sash side member 33 as well. The longitudinal extension of the foam element 32f may be such that the foam element 32f extends over a major part of the length of the sash side member 32. The foam element 32f abuts the interior side of the head portion 32b2 of the intermediate element 32b along the extent of the intermediate element 32b, and is allowed to expand towards the interior side of the head portion 32a1 of the profile element 32a of the side sash member 32 in the portions of the foam element 32f protruding beyond the longitudinal ends of the intermediate element 32b. The foam element 32f has general climate shielding properties.

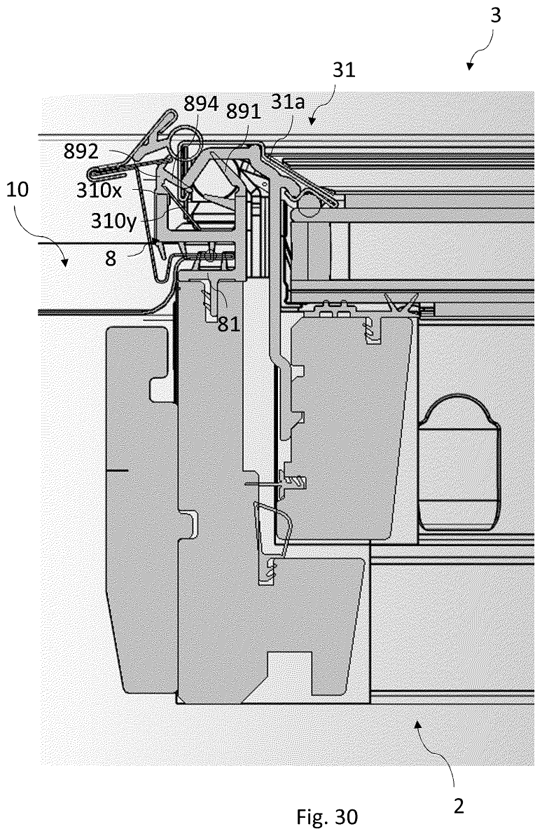

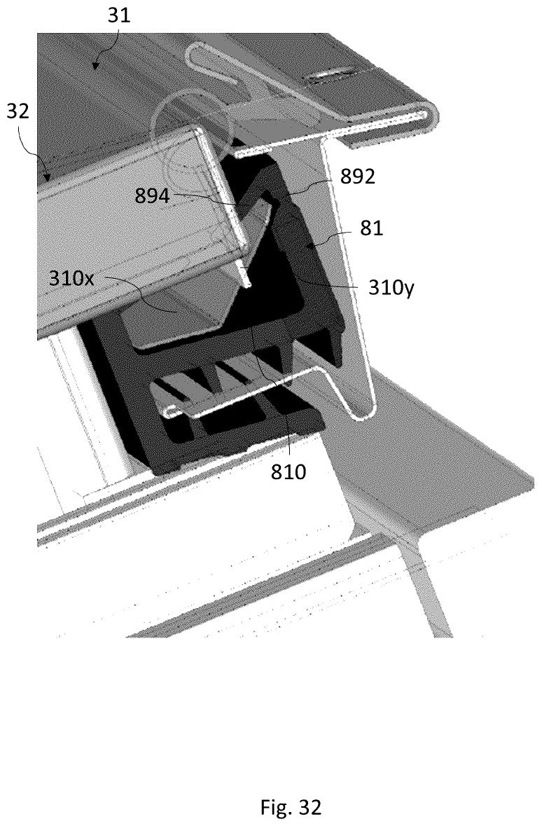

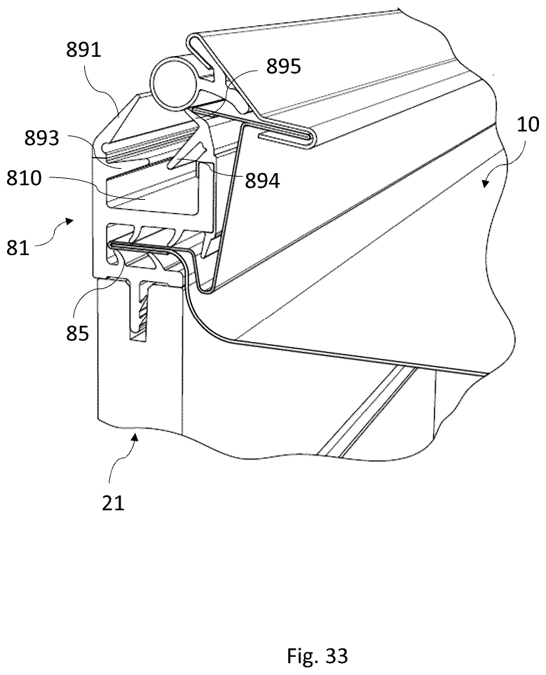

In FIG. 30, a stabilising plate 310x is placed in the channel 810 of the top element 81 of the interface unit 8 to improve the structural properties. Furthermore, an extension plate 310y is shown fastened to the profile element 31a of the top sash member 31 to protrude into the channel 810. The extension plate 310y improves guidance of precipitation into the channel 810 and for further guidance towards the sides of the roof window. This is particularly relevant in roof windows built into roofs of a large inclination. The relative positions of the stabilising plate 310x and the extension plate 310y are shown more clearly in FIG. 32. For ease of reading of the relevant portions of the interface unit 8, FIG. 33 shows the top element 81 of the interface unit 8 without the stabilising plate 310x and without the sash 3 including the extension plate 310y.

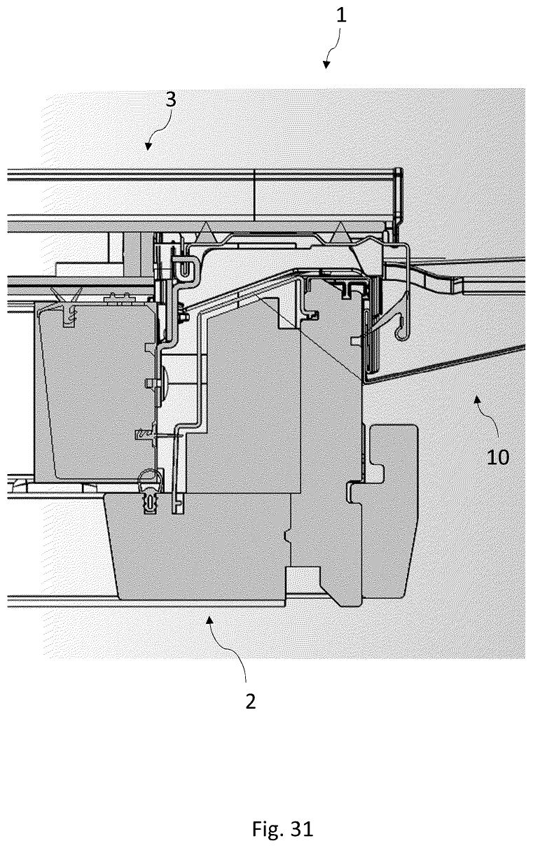

FIG. 31 shows the interaction between the bottom of the roof window 1 and the covering assembly 10.

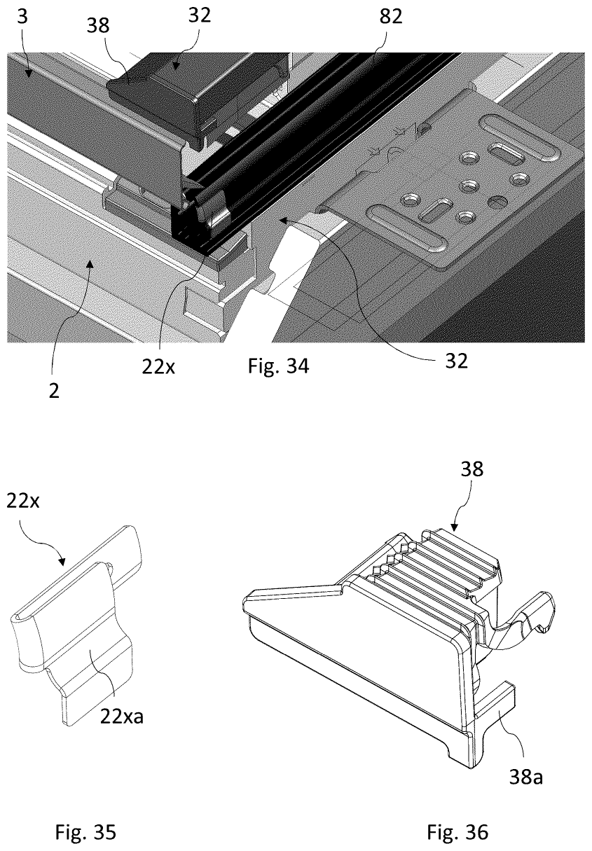

Finally, FIG. 34 show a view of the lower right-hand corner of the roof window 1, in which the sash 3 has been lifted slightly relative to the frame 2 for clarity reasons.

Here, a clip 22x is mounted on the side element 82 of the interface unit 8. The clip 22x is provided with a clip flange 22xa as shown in more detail in FIG. 36. The end plug 38 of the sash side member 32 is in this embodiment provided with an end plug flange 38a. In the closed position of the roof window 1, the end plug flange 38a overlaps the clip flange 22xa.

In general, components of the roof window are easily disassembled and each component may in principle be reused, be recycled by appropriate environmentally responsible disposal means, or the material be recovered for other uses.

### LIST OF REFERENCE NUMERALS

1 roof window
2 frame
   21 top frame member
   21i inwards protruding portion
   22 side frame member
   22c adapted side frame member
   22i inwards protruding portion
   22s abutment element
   22x clip
   22xa clip flange
   23 side frame member
   24 bottom frame member
   24a outer piece of bottom frame member
   24a1 receiving groove
   24b separate inner piece of bottom frame member
   24b1 receiving groove
   24c cover
   24c1 edge portion
   24c2 edge portion
   24d insulating piece
   24i inwards protruding portion
   25 lining groove
   25a first groove portion
   25b second groove portion
   26 sealing groove
   26p frame sealing profile
   27 first outer groove
   27b second outer groove
   28 interface unit groove
   29a hinge assembly receiving milling
   29b hinge assembly receiving milling
   29c opening
   29d opening
   29e through-going opening
   29f opening
3 sash
   30g1 sash sealing groove
   30p1 sash sealing profile
   30g2 pane sealing groove
   30p2 pane sealing
   30x fastening means
   30y fastening means
   31 top sash member
   31a profile element of top sash member
   31b intermediate element
   31c inner element
   310x stabilising plate
   310y extension plate
   32 side sash member
   32a profile element of side sash member
   32a1 head portion
   32a2 inner portion
   32a3 outer portion
   32a4 first bend
   32a5 second bend
   32a6 third bend
   32a7 transition portion
   32a8 fourth bend
   32b intermediate element
   32b1 base portion
   32b2 head portion
   32b3 engagement means/protruding portion/flange
   32b4 stepped section
   32b5 offsetting bend
   32b6 opening
   32b7 ridge portion
   32b8 inner inclined portion
   32b9 inner edge portion
   32b10 bend
   32b11 outer inclined portion
   32b12 outer edge portion
   32c inner element
   32c1 reception means/first groove
   32c2 reception means/second groove
   32f foam element
   32s screening mounting bracket
   33 side sash member
   33a profile element of side sash member
   33b intermediate element
   33c inner element
   34 bottom sash member
   34a profile element of bottom sash member
   34a1 head portion
   34a2 inner portion
   34a3 outer portion
   34a4 groove in head portion 34a1
   34a5 slit in inner portion 34a2
   34b intermediate element
   34b0 first fitting part of connecting fitting
   34b1 base portion
   34b2 head portion
   34b3 engagement means/protruding portion
   34b4 stepped section
   34b5 offsetting bend
   34b6 opening
   34b10 second fitting part of connecting fitting
   34b11 resilient hook
   34c inner element
   34c1 reception means/first groove
   34c2 reception means/second groove
   34p profile element sealing
   37 trailing element
   38 end plug
   38a end plug flange
   39 corner key
   39a1 leg
   39a2 channel
   39a3 primary opening
   39a4 depending skirt
   39a5 secondary opening
   39a6 inclined section
   39a7 tongue
   39a8 inclined channel section
   39b sealant
4 pane
   41 exterior sheet
   41a extended portion
   41b bottom edge portion of exterior sheet
   42 interior sheet
   42b bottom edge portion of interior sheet(s)
   43 additional interior sheet
   44 masking
   45 glazing bar
   45a adhesive strip
   46 glazing bar cover element
   47 spacer
   4b side edge portion of pane
   4c top edge portion of pane
   4e exterior surface of pane
   4i interior surface of pane
   4p sealing (pane)
   4s sealing strip (pane)
   4t pane clip
5 operating assembly
   51 socket fitting
   511 base plate of socket fitting
   512 flanges of socket fitting
   513 holes
   52 spindle part
   521 spindle
   522 handle
   53 nut part
   531 nut ring
   532 bolts
   54 end portion
   55 sash fitting
   551 base plate of sash fitting
   552 flanges of sash fitting
   553 openings
   56 split
6 mounting bracket
   61 first bracket leg
   614 bend
   62 second bracket leg
   620 aperture
   621 first section
   624 first engagement means/flange
   625 hinge connection
   626 second section
   629 second engagement means/flange
7 insulating frame
   71 top piece of insulating frame
   72 side piece of insulating frame
   73 side piece of insulating frame
   74 bottom piece of insulating frame
   75 indentation
   76 recess
   77 folding line
   78 protrusion
8 interface unit
   80 base portion
   801 anchor section
   81 top element of interface unit
   810 channel in top interface element
   82 side element of interface unit
   820 channel in side interface element
   83 side element of interface unit
   84 bottom element of interface unit
   85 flashing reception groove
   85a protrusions
   85b groove opening
   86 inner leg
   87 outer leg
   88 flange
   89 sealing portion
   891 inner sealing lip
   892 outer sealing lip
   893 additional inner sealing lip
   894 first additional outer sealing lip
   895 second additional outer sealing lip
9 hinge assembly
   91 hinge unit
   92 frame hinge part
   93 sash hinge part
   94 hinge pin
   95 coupling unit
   96 top frame coupling plate
   961 base section
   961c spigot
   962 bolt/engagement pin
   963 bolt/engagement pin
   97 side frame coupling plate
   971 base section
   971e spigot
   981 screw
   982 insert nut
   983 insert nut
10 covering assembly

1. A roof window comprising a frame, a sash, and a pane, in which
the frame comprises a set of frame members including a top frame member, two side frame members and a bottom frame member and the sash comprises a set of sash members including a top sash member, two side sash members and a bottom sash member,
an interface unit being is provided to interact with auxiliary equipment and/or other components of the roof window in an assembled condition of the frame,
characterised in that
the interface unit comprises a top interface element and two side interface elements configured to be received in a receiving structure comprising an interface unit groove in an exterior side of the top frame member and two side frame members, said exterior side being a side of a roof window in the mounted condition facing the outdoors or external side of the building, that
each interface element comprises a base portion with an anchor section, said anchor section being configured to be received in the interface unit groove in the exterior side of the top frame member and two side members, and in that
each interface element is provided as a two-component element provided by co-extrusion or co-moulding of two or more different materials, wherein at least a sealing portion has different properties than at least the base portion.

2. (canceled)

3. (canceled)

4. The roof window according to claim 1, wherein the interface unit forms part of an exterior sealing plane relative to the sash.

5. The roof window according to claim 4, wherein the exterior sealing plane is provided by the top interface element at the top frame member and the top sash member and the two side interface elements at the two side frame members and the two side sash members.

6. The roof window according to claim 5, wherein each interface element comprises an inner leg and an outer leg, which inner leg and outer leg extend towards the exterior from the base portion, and each interface element further includes a flange and a sealing portion.

7. The roof window according to claim 6, wherein the inner leg, the outer leg, and the flange form a channel in the top interface element and the two side interface elements.

8. The roof window according to claim 6, wherein the sealing portion comprises an inner sealing lip and an outer sealing lip.

9. The roof window according to claim 8, wherein the top interface element comprises an additional inner sealing lip, a first additional outer sealing lip and a second additional outer sealing lip.

10. The roof window according to claim 6, wherein the base portion, the inner leg and the flange form a flashing reception groove.

11. (canceled)

12. The roof window according to claim 7, wherein a stabilising plate is placed in the channel of the top interface element of the interface unit.

13. The roof window according to claim 7, wherein an extension plate is fastened to a profile element of the top sash member to protrude into the channel of the top interface element of the interface unit.

14. The A roof window according to claim 1, wherein a clip is mounted on one of the two side interface elements of the interface unit, and wherein the clip is provided with a clip flange to interact with an end plug flange of an end plug of a corresponding side sash member so as to allow the end plug flange to overlap the clip flange in the closed position of the roof window.

15. The roof window according to claim 10, wherein the flashing reception groove being provided with a series of protrusions protruding from the base portion and from the flange.

16. The roof window according to claim 7, wherein the sealing portion comprises an inner sealing lip and an outer sealing lip.

17. The roof window according to claim 7, wherein the base portion, the inner leg and the flange form a flashing reception groove.

18. The roof window according to claim 17, wherein the flashing reception groove being provided with a series of protrusions protruding from the base portion and from the flange.

19. The roof window according to claim 8, wherein a stabilising plate is placed in a channel of the top interface element of the interface unit.

20. The roof window according to claim 9, wherein a stabilising plate is placed in a channel of the top interface element of the interface unit.

21. The roof window according to claim 8, wherein an extension plate is fastened to a profile element of the top sash member to protrude into a channel of the top interface element of the interface unit.

22. The roof window according to claim 9, wherein an extension plate is fastened to a profile element of the top sash member to protrude into a channel of the top interface element of the interface unit.

23. The roof window according to claim 4, wherein a clip is mounted on one of the two side interface elements of the interface unit, and wherein the clip is provided with a clip flange to interact with an end plug flange of an end plug of a corresponding side sash member so as to allow the end plug flange to overlap the clip flange in the closed position of the roof window.
